(19) United States
(12) Patent Application Publication
(10) Pub. No.: US 2022/0139263 A1
(43) Pub. Date: May 5, 2022

(54) SPINE MODEL

(71) Applicant: OrthoPediatrics Corp., Warsaw, IN (US)

(72) Inventors: Miranda Roberson, Williamsville, NY (US); Veronica Edyta Gawarecki, Okemos, MI (US); Matthew Philip Prygoski, North Liberty, IN (US); Richard Detlefsen, Warsaw, IN (US); Richard Michael Schwend, Kansas City, MO (US)

(21) Appl. No.: 17/517,854

(22) Filed: Nov. 3, 2021

Related U.S. Application Data
(60) Provisional application No. 63/109,792, filed on Nov. 4, 2020.

(51) Int. Cl. G09B 23/32

(52) U.S. Cl. CPC G09B 23/32

(57) ABSTRACT

A spine model. The spine model includes a disc, the disc having a first disc face and a second disc face. The first disc face and the second disc face are substantially parallel to each other and orthogonal to a rotational axis. A fixed first vertebrae is operationally joined to the disc at the first disc face such that the fixed first vertebrae cannot rotate about the rotational axis relative to the first disc face. A rotatable second vertebrae, rotatable about the rotational axis and operationally joined to the disc at the second disc face such that the rotatable second vertebrae cannot rotate about the rotational axis relative to the second disc face.

### CROSS-REFERENCE TO RELATED APPLICATION

This application claims the benefit of U.S. Provisional Application Ser. No. 63/109,792, filed Nov. 4, 2020, the disclosure of which is hereby incorporated herein by reference in its entirety.

### TECHNICAL FIELD

Embodiments of the technology relate to an apparatus, system and techniques for modeling a human spine, including training systems and methods relating to spinal surgery.

### BACKGROUND

The spinal column is comprised of bones and tissues that provide structural support and balance along with support and protection for the nervous system. It holds the body upright and allows it to bend and twist easily, each functional unit having six degrees of freedom. A functional unit is composed of two adjacent vertebrae, two facet joints and capsules, connecting ligaments, and an intervertebral disc. These intervertebral discs act as interbody spacers and shock absorbers under various compressive, rotational, and bending movements.

Various spinal conditions and injuries exist, one prevalent condition being scoliosis which is characterized by an unnatural curvature of the spine. Deformities can occur in all three planes, and surgery is often required to correct these deformities and ease the pain/discomfort caused by this condition. Surgeons use various orthopedic instruments to correct these deformities, and often practice on models or cadavers. However, these models and cadavers have many limitations. Scoliosis deformities are specific to each patient, so the exact condition is not replicated in a cadaver or in these models. Additionally, these models and cadavers lack the mechanical properties of an actual spine. Therefore, using the instruments on a preoperative model or cadaver is very different than using them on a living patient in surgery. Finally, specifically when working with pediatric cases, there is a lack of cadavers for surgeons to practice on.

Accordingly, there remains an unmet need for an apparatus, system, and method to provide more realistic spinal models for any of training, preoperative training and/or demonstration.

Additionally, there remains an unmet need for a spinal model having realistic mechanical properties and the capability of creating pediatric patient-specific deformities.

Further, there remains an unmet need for an apparatus, system, and method to provide surgeons the opportunity to better prepare for specific scoliosis cases and demonstrate on a spinal model the capabilities of different implant/instrument systems.

### BRIEF DESCRIPTION OF THE DRAWINGS

The present disclosure will be more readily understood from a detailed description of some example embodiments taken in conjunction with the following figures:

FIG. 1 depicts a schematic representation of a human body sectioned in the axial, sagittal and coronal planes.

FIG. 2 is an exploded view of a spine model of the present disclosure.

FIG. 2A is an exploded view of a spine model of the present disclosure.

FIG. 2B is a perspective view of a double curve disc of the present disclosure.

FIG. 3 is a perspective view of a thoracic vertebrae for use in spine models of the present disclosure.

FIG. 4 is a perspective view of a lumbar vertebrae for use in spine models of the present disclosure.

FIG. 5 is a perspective view of a vertebrae for use in spine models of the present disclosure.

FIG. 6 is a schematic view showing alignment features of a disc of the present disclosure.

FIG. 7 is a schematic view showing alignment features of a disc of the present disclosure.

FIG. 8 is a schematic view of a disc of the present disclosure.

FIG. 9 is an exploded view of a spine model of the present disclosure.

FIG. 10 is a schematic view of a disc of the present disclosure.

FIG. 11 is a schematic view showing alignment features of a disc of the present disclosure.

FIG. 12 is a schematic view showing alignment features of a disc of the present disclosure.

FIG. 13 is a perspective view of a spine model of the present disclosure.

FIG. 14 is an exploded view of the spine model shown in FIG. 13.

FIG. 15 is a perspective view of a wedge of the present disclosure.

FIG. 16 is a side view of a wedge of the present disclosure.

FIG. 17 depicts a 3D model of a spine.

FIG. 18 depicts a 2D model of the spine shown in FIG. 17.

FIG. 19 depicts a 3D model of a spine.

FIG. 20 depicts a 2D model of the spine shown in FIG. 19.

FIG. 21 depicts a 3D model of a spine.

FIG. 22 depicts a 2D model of the spine shown in FIG. 21.

FIG. 23 depicts a 3D model of a spine.

FIG. 24 depicts a 2D model of the spine shown in FIG. 23.

FIG. 25 depicts a 3D model of a spine.

FIG. 26 depicts a 2D model of the spine shown in FIG. 25.

FIG. 27 depicts a 3D model of a spine.

FIG. 28 depicts a 2D model of the spine shown in FIG. 27.

FIG. 29 depicts a 3D model of a spine.

FIG. 30 depicts a 2D model of the spine shown in FIG. 29.

FIG. 31 depicts a 3D model of a spine.

FIG. 32 depicts a 2D model of the spine shown in FIG. 31.

FIG. 33 depicts a 3D model of a spine.

FIG. 34 depicts a 2D model of the spine shown in FIG. 33.

FIG. 35 depicts a 3D model of a spine.

FIG. 36 depicts a 2D model of the spine shown in FIG. 35.

FIG. 37 depicts a 3D model of a spine.

FIG. 38 depicts a 2D model of the spine shown in FIG. 37.

FIG. 39 depicts a 3D model of a spine.

FIG. 40 depicts a 2D model of the spine shown in FIG. 39.

FIG. 41 is a perspective view of a spine model of the present disclosure.

FIG. 42 is an enlarged image of the inset image 42 in FIG. 41.

FIG. 43 is a perspective view of a vertebrae of the present disclosure.

FIG. 44 is a side view of a vertebrae of the present disclosure.

FIG. 45 is a perspective view of a vertebrae of the present disclosure.

FIG. 46 is a side view of a vertebrae of the present disclosure.

FIG. 47 is a side view of a spring-wire portion of a spine model of the present disclosure.

FIG. 48 is a side view of a spring-wire portion of a spine model of the present disclosure.

FIG. 49 is a side view of a test stand for a spine model of the present disclosure.

FIG. 50 is a perspective view of a spine model of the present disclosure.

FIG. 51 is a partial cut-away view of the spine model shown in FIG. 50.

FIG. 52 is a perspective view of a spine model of the present disclosure.

FIG. 53 is a perspective view of a spine model of the present disclosure.

FIG. 54 is a side view of a spine model of the present disclosure.

FIG. 55 is a perspective view of a kit of the present disclosure.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

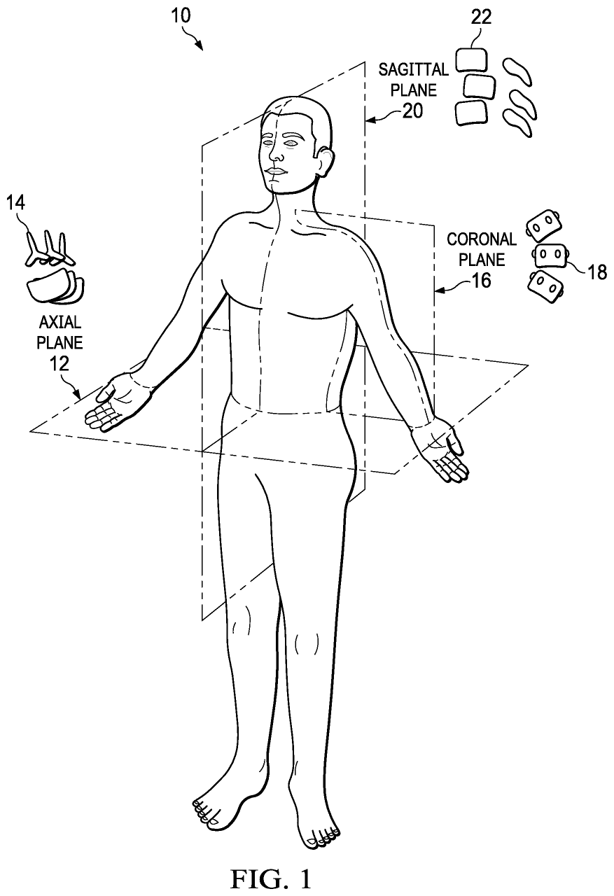

Described herein are example embodiments of a spine model that facilitates more realistic modeling of the curvature of a spine in one or more of three dimensions, represented in human anatomy as three reference planes: the transverse plane, the coronal plane, and the sagittal plane. Referring to FIG. 1, there is depicted a representative human body 10 showing these three reference planes in the specific context of their relevance to the curvature of the human spine. Thus, the following terms are defined in reference to the disclosed spinal model as it relates to the human anatomy in the upright (standing) orientation.

An axial (also known as transverse or horizontal) plane 12 is parallel to the ground; in humans it separates the superior from the inferior, or put another way, the head from the feet. A schematic representation of axial misalignment of several vertebrae 14 is indicated.

A coronal (also known as frontal) plane 16 is perpendicular to the ground; in humans it separates the anterior from the posterior, the front from the back. A schematic representation of coronal misalignment of several vertebrae 18 is indicated.

A sagittal (also known as anteroposterior) plane 20 is perpendicular to the ground, separating left from right. A schematic representation of sagittal misalignment of several vertebrae 22 is indicated.

For each example embodiment of various spine models disclosed herein, there is a disc element and/or a wedge element that resides between two vertebrae elements. For example, the spine model 100 described in detail below comprises a disc 106; the spine model 200 comprises a disc 206; and the spine models 300 and 400 comprise discs 306 and wedges 360. In each embodiment the material of the disc and/or wedge of the disclosed spine model can be selected to have mechanical properties that closely match the mechanical properties of the disc in a human spine, including its supporting and connecting ligaments. That is, the discs and/or wedges disclosed herein can have mechanical properties that closely match the fibrocartilaginous joint properties of the disc in a human spine. In an embodiment, the disc (e.g., 106, 206, 306) and the wedges (e.g., 360) can comprise a polymer. In an embodiment, the disc (e.g., 106, 206, 306) and the wedges (e.g., 360) can comprise an elastomeric polymer. In an embodiment, the disc and/or wedge can be a polymer having a Durometer selected for a balance of compressive and elastomeric properties, including bending compression and torsional elasticity. In an embodiment, the material of the disc and/or wedge can be selected to be printable on a 3-D printer. In an embodiment, the material of the disc and/or wedge can have an XY tensile strength (ISO 527) of about 7 MPa, a Z tensile strength (ISO 527) of about 5.5 MPa, a Young's modulus (ISO 527) of about 65 MPa, an elongation to break XY (average) (ISO 527) of about 350%, an elongation to break Z (average) (ISO 527) of about 200%, and/or a Shore Test (Shore A) of about 70+/−5. In an embodiment, the material of the disc and/or wedge can comprise a polyurethane, including a polyurethane blend. In an embodiment, the material of the disc and/or wedge can be TPU-70A. In an embodiment, the disc and/or wedge can have relief cuts, depressions, or through-cuts, such as the relief cuts 132 as shown in FIG. 8. Relief cuts can provide additional design vectors related to providing a disc having mechanical properties that more closely represent the mechanical properties of a human spinal disc. In an embodiment, the disc and/or wedge can be produced on a 3D printer, such as a Prodways machine ProMaker P1000, utilizing TPU-70A material that can be selectively sintered to produce an article of desired size and shape. In an embodiment, the material of the wedge can be relatively harder than the disc, and can be characterized as hard plastic.

For each example embodiment of various spine models disclosed herein, there are at least two vertebrae elements. Vertebrae elements can be made of plastic, including relatively hard, non-compressible plastic, or other materials such as, for example, metals or composite materials.

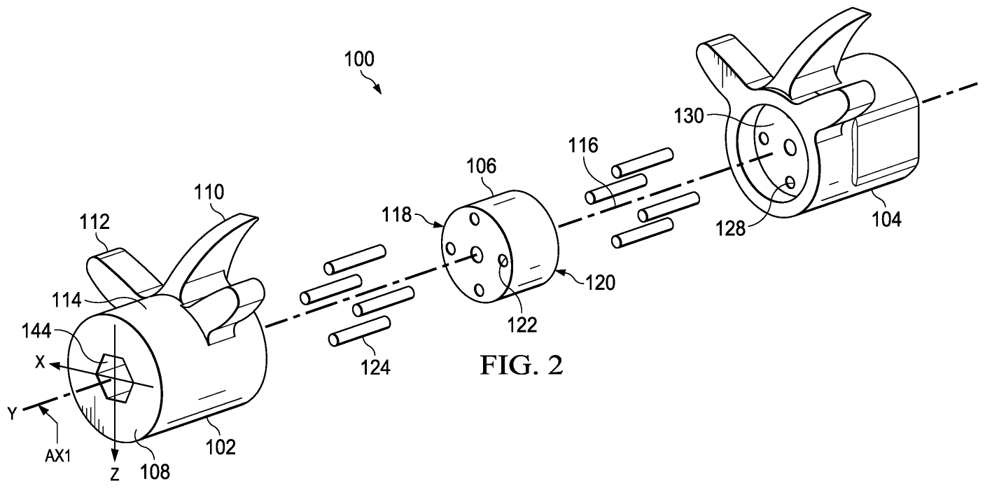

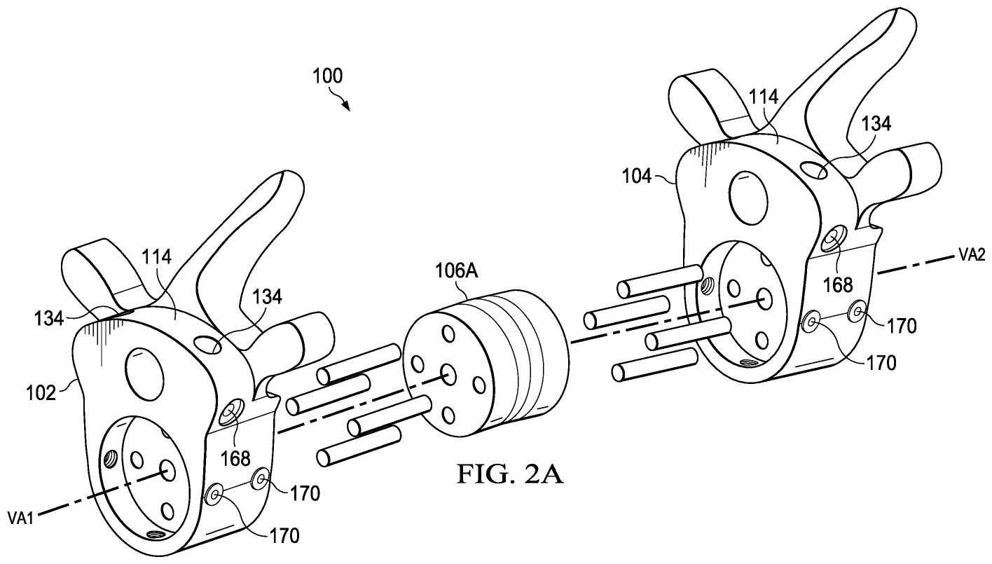

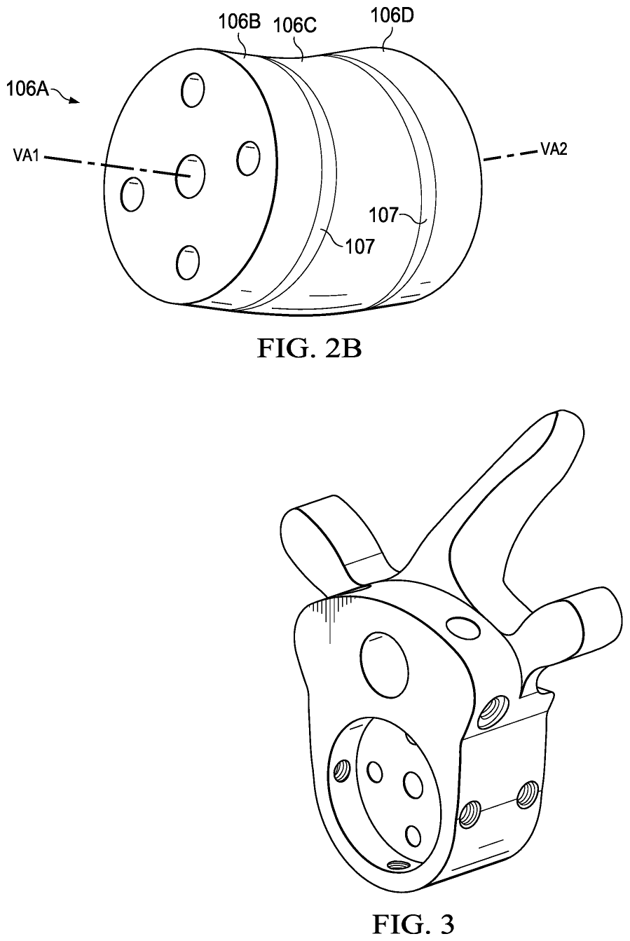

Referring to FIG. 2, a representative example of one embodiment of a spine model is shown. The spine model 100 is useful for modeling transverse spinal misalignment and training in aligning human spines in need of transverse alignment, and referred to herein as derotation. This representative embodiment can be a segment of a more complete model comprising a greater plurality of vertebrae members and discs members. In the embodiment shown in FIG. 2, two vertebrae are shown, a first vertebrae 102 and a second vertebrae 104, each of which are joined to a disc 106. In the spine model each vertebrae can be sized and shaped to closely resemble an actual human vertebrae, including having portions identified as the vertebral body 108, the spinous process 110, laterally extending transverse processes 112, and a pedicle 114. Additionally, the size and shape can be predetermined to model cervical, thoracic (upper and lower) or lumbar vertebrae.

A representative model of an upper thoracic vertebrae useful in any of the models of the present disclosure is shown in FIG. 3. A representative model of lumbar vertebrae useful in any of the models of the present disclosure is shown in FIG. 4. A representative model of a lower thoracic vertebrae useful in any of the models of the present disclosure is shown in FIG. 5.

Continuing to refer to FIG. 2, in a transversely aligned human spine, the spinous processes of two adjacent vertebrae are substantially aligned in the same plane, such as in the plane of the Y-Z axis in FIG. 2, which corresponds to the sagittal plane of the human body. If one of adjacent vertebrae is rotated, for example, rotated about the Y-axis of the spine model 100, also denoted in FIG. 2 as the rotational axis AX1, which corresponds to rotation in the transverse plane of the human body, the spine can be considered to be in transverse misalignment. The process of derotation of the spine, that is, realigning adjacent vertebrae such that their respective vertebrae are in proper alignment, can be modeled with the spine model 100 by using the disc 106 of the present disclosure. The disc 106 can be generally cylindrical in shape, including being a right circular cylinder in shape. In an embodiment, the cylinder longitudinal axis 116 can be parallel to and coaxial with the Y-axis, which can be the spine model 100 rotational axis AX1. In an embodiment the disc 106 can have an elliptical shape, kidney-bean shape, oval shape, and other shapes suitable for use as a disc in the spine models disclosed herein.

As shown in FIG. 2, the disc 106 can have a first disc face 118 and a second disc face 120, each of which can each be substantially planar, parallel to the other, and orthogonal to the rotational axis AX1. By “planar” or “substantially planar” is not intended to mean absolutely flat and/or smooth, but is intended to convey the general appearance of the faces so described. Unless otherwise disclosed as such, the terms “planar” or “substantially planar” do not exclude faces that have certain indentations, protrusions, engravings, etchings, and the like. The diameter of the disc 106 and the distance separating the first disc face 118 and the second disc face 120 can be selected to model the corresponding dimensions of a disc of a human spine, and/or the mechanical properties of a disc of a human spine. Each of the first disc face 118 and the second disc face 120 can have at least one disc pin-receiving receptacle 122 that serves to receive, seat, and/or otherwise secure the end of an alignment pin 124 inserted therein. As shown in FIG. 2, the disc pin-receiving receptacle 122 can be a generally cylindrical-shaped hole that has a depth sufficient to securely hold the end of a cylindrical-shaped alignment pin 124 during the use of the spine model 100. In an embodiment, one or both disc faces can have from two to eight disc pin-receiving receptacles 122. In an embodiment, the alignment pins 124 need not be cylindrical shaped, but can have polygonal cross-sections or irregularly-shaped cross-sections, as long as they serve to enter the relevant pin-receiving receptacles when the vertebrae are operationally joined to the disc. In an embodiment, the alignment pins 124 are 3 mm diameter stainless steel pins having a length of between about ¼ inch and about two inches.

In the embodiment shown in FIG. 2 each of the first vertebrae 102 and the second vertebrae 104 have a disc-facing surface 130 that adjoins the first disc face 118 and the second disc face 120, respectively, when the elements of the spine model 100 are operationally joined (in FIG. 2, the disc facing surface 130 of the first vertebrae 102 is not showing due to the perspective orientation). On each of the disc-facing surfaces 130 there is at least one corresponding vertebrae pin-receiving receptacle 128. Each of the vertebrae pin-receiving receptacles 128, four of which are on each of the disc-facing surfaces 130 in FIG. 2, can be a generally cylindrical-shaped hole that has a depth sufficient to securely hold the end of an alignment pin 124 during the use of the spine model 100. In an embodiment, the disc-facing surface 130 of one or both of the first vertebrae 102 and the second vertebrae 104 can be recessed, as indicated in FIG. 2, such that a portion of the disc 106 resides in the recess when the disc and vertebrae are operationally joined. The presence of a recessed disc-facing surface 130 can aid in stabilizing the disc 106 with respect to lateral movement. As with the disc 106, in an embodiment, each of the first vertebrae 102 and the second vertebrae 104 disc-facing surfaces 130 can have from two to eight vertebrae pin-receiving receptacles 128.

FIG. 2A shows a similar spine model 100 as depicted in FIG. 2 having the same features and benefits, but with some different features and some additional features. As shown in FIG. 2A, each vertebrae, including the first vertebrae 102 can have on each side a disc-facing surface 130. Further, each vertebrae can have on the pedicle 114 thereof a pedicle screw receiving port 134. A pedicle screw can be secured in the pedicle screw receiving port 134, such as by being secured by a pedicle screw set screw 168 that can be threaded from the side of the vertebrae to the pedicle screw receiving port 134. Also shown in FIG. 2A is the optional disc-securing set screws 170. The disc-securing set screws 170 can be positioned such that a set screw can be threaded through a portion of the vertebrae into the recessed portion of the disc-facing surfaces 130 to hold the discs in place to avoid axial movement when forces are applied.

Further, shown in FIG. 2A is a multi-curve disc 106A that can provide for modeling curvature of a human spine from two-dimensional images. When the spine model 100 utilizes a multi-curve disc 106A, the first vertebrae 102 axis VA1 is not parallel to the second vertebrae 104 axis VA2. The spine curvature modeling is achieved by the multi-curve disc 106A, as shown in FIG. 2B, that can be made of several components, and thereby facilitates building a specific curvature of the modeled spine in three dimensions. For example, a first disc component 106B, a second disc component 106C, and a third disc component 106D can be modeled, such as in a CAD program, and then virtually joined such that the part can be produced as a unitary member. In another embodiment, the various parts modeled can be individually produced and joined at joints 107 to make a multi-curve disc 106A that can provide for curvature in multiple planes. In an embodiment, for example, two-dimensional images of a human spine can be analyzed to determine the two-dimensional curvature in each of the coronal and sagittal planes. The multi-curve disc 106A can then be modeled and constructed from this data with each of the two-dimensional curves accommodated by one angled face of one of the multiple components (either actual individual components or virtual components) of the multi-curve disc 106A. Thus, in an embodiment of a spine model, the disc can be a multi-component multi-curve disc 106A composed of one or more distinct curves, and with one or more vertebral alignment features, that orients two adjacent vertebrae in 3D space such that local coronal, sagittal and/or transverse plane deformities are approximated to those of a human spine when 2D projections are taken onto each of those anatomical planes. In an embodiment, the multi-curve disc 106A can be a disc having a curvature of the portion corresponding to the spinal cord of a human spine. In an embodiment, the multi-curve disc 106A can have a substantially uniform cross-section along its length from one face to the other.

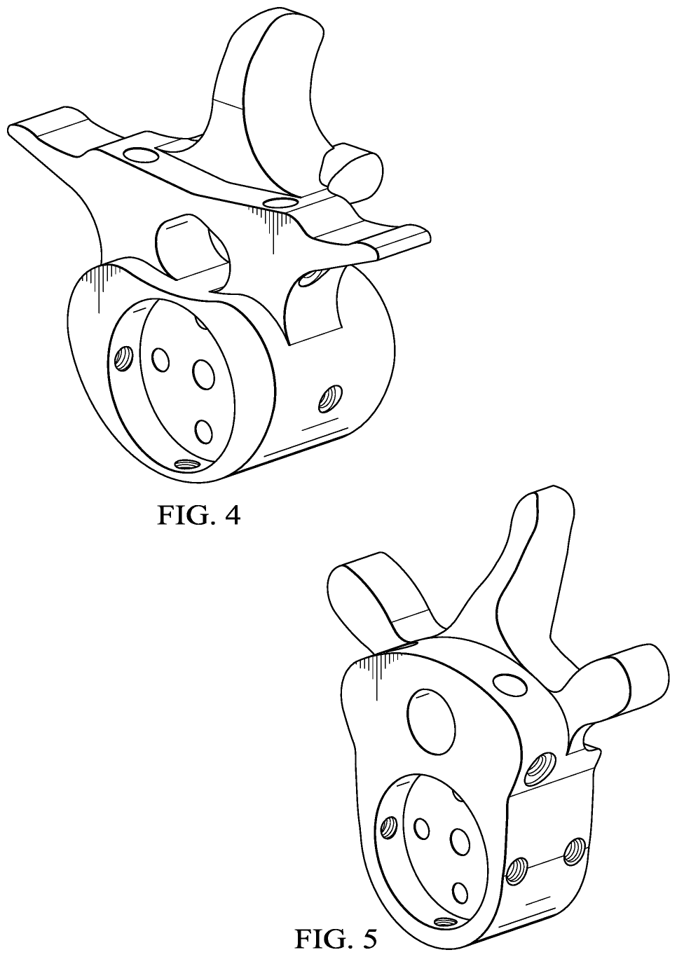

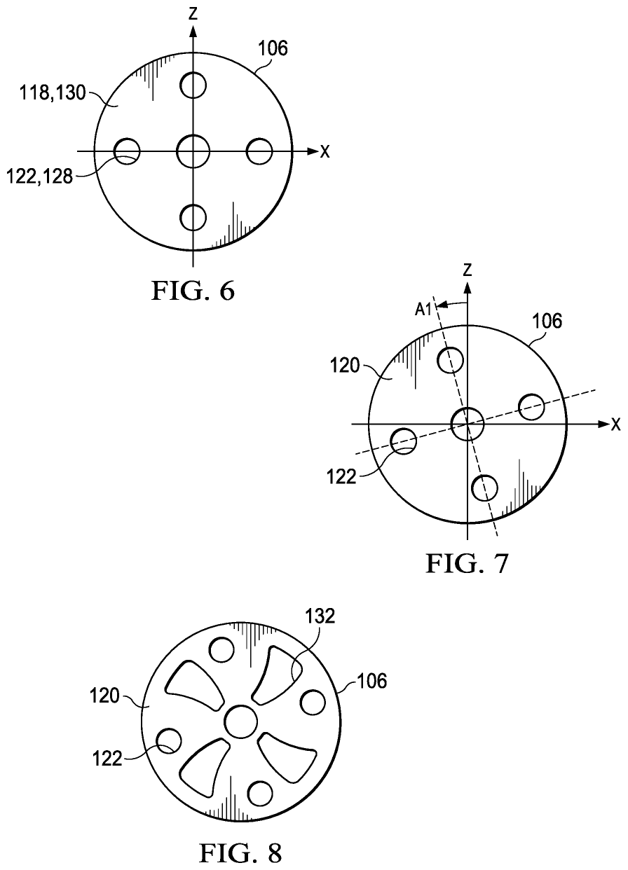

Referring now to FIGS. 6 and 7, the principle of operation of the spine model 100 in modeling human spine derotation can be more fully understood. FIG. 6 depicts schematically a superior view of the disc 106, and depicts both or either of (1) the first disc face 118 and the placement and orientation of pin-receiving receptacles 122, and (2) one or both of disc-facing surfaces 130 of the first vertebrae 102 and the second vertebrae 104 and orientation of the vertebrae pin-receiving receptacles 128. As illustrated, there is depicted an embodiment utilizing four pin-receiving receptacles on each of the depicted surfaces, which can be disc pin-receiving receptacles 122 or vertebrae pin-receiving receptacles 128. That is, for purposes of illustration, FIG. 6 is depicted as being the placement and orientation of the disc pin-receiving receptacles 122 of first disc face 118, and the placement and orientation of the vertebrae pin-receiving receptacles of both the disc-facing surfaces 130 of the first vertebrae 102 and the second vertebrae 104. FIG. 7 depicts schematically the second disc face 120 and the placement and orientation of disc pin-receiving receptacles 122. As can be understood with reference to the Z-X coordinates, the disc pin-receiving receptacles 122 of the second disc face 120 are oriented at offset angle A1 from those of the first disc face 118.

As can be understood, therefore, when the first vertebrae 102 having the characteristics described herein is coupled to the disc 106 with alignment pins 124 engaged with the vertebrae pin-receiving receptacles 128 and the disc pin-receiving receptacles 122 on the first disc face 118, the first vertebrae 102 is then “locked,” rotationally, i.e. unable to rotate about the rotational axis AX1 relative to the disc 106. Likewise, second vertebrae 104 having the characteristics described herein is coupled to the disc 106 with alignment pins 124 engaged with the vertebrae pin-receiving receptacles 128 and the disc pin-receiving receptacles 122 on the second disc face 120, the second vertebrae 104 is then “locked,” rotationally, i.e. unable to rotate about the rotational axis AX1 relative to the disc 106.

The components of the spine model 100 are operationally joined when both vertebrae are in rotationally locked relationship with the disc 106. When the components of the spine model 100 are operationally joined the second vertebrae 104 will be in rotational misalignment with the first vertebrae 102, by an amount equal to the magnitude of the offset angle A1, as depicted in FIG. 7. However, because the disc 106 can be made of a flexible material, such as an elastomeric polymer, the second vertebrae 104 can be rotationally urged against the elastomeric forces of the disc 106, including torsional forces, into a position corresponding to proper alignment of a human spine. In this manner the spine model 100 can provide for realistic training for derotation or other alignments of a human spine in need of derotation or other alignments. In an embodiment of the spine model 100, one of the first vertebrae 102 or the second vertebrae 104 can be securely clamped, for example, to a training table to keep it from moving during the derotation training process. In an embodiment, certain features of one or both of the first vertebrae 102 or the second vertebrae 104, such as the hex opening 144 shown in FIG. 2, can be used to provide for a torque-resistant securement for derotation modeling and training.

In an embodiment, a system of the spine model 100 can include two or more vertebrae, one or more discs 106, and a plurality of alignment pins 124. The two or more discs 106 can include discs 106 in which the offset angle A1 for the disc pin-receiving receptacles 122 on the second disc face 120 is varied. In an embodiment, a system or kit of the spine model 100 can include a plurality of discs 106 in which for each disc 106 the offset angle A1 for the disc pin-receiving receptacles 122 on the second disc face 120 can vary in predetermined angular increments, such as increments of 2-5 degrees. The offset angle A1 can be, for example, 5 degrees, 10 degrees, 15 degrees, or 20 degrees, etc. It is understood that the angle A1 can be any angle desired.

In a method of use of a system of the spine model 100, a disc 106 having the desired offset angle A1 for the disc pin-receiving receptacles 122 on the second disc face 120 can be selected. The selected disc 106 can then be operationally joined with a first vertebrae 102 and the second vertebrae 104. The second vertebrae 104 can then be rotationally urged against the elastomeric resistance of the disc 106 until the first vertebrae 102 is in rotational alignment with the second vertebrae 104.

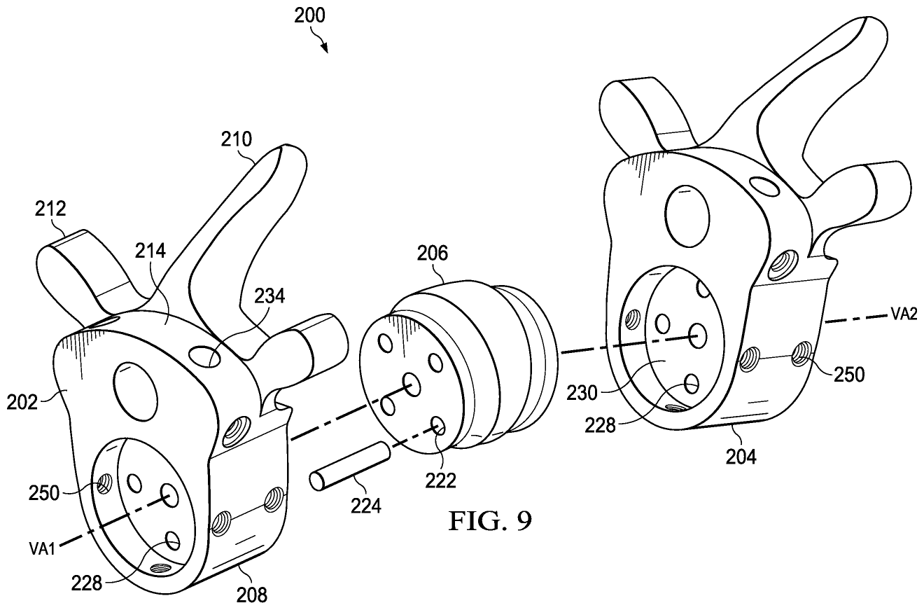

The spine model 100 described above can be utilized for training in derotation of a human spine, that is, training in proper alignment of a human spine that is misaligned and in need of alignment in the transverse plane only. For training in spine alignment in either or both of the coronal and sagittal planes, another embodiment of a spine model can be utilized, for example, the spine model 200 shown in FIGS. 9 and 10. The spine model 200 can be used for training in spinal derotation in the same manner as described above with respect to the spine model 100. However, the spine model 200 can also be used for training in one or both of coronal and sagittal alignment.

Referring to FIG. 9, a representative example of another embodiment of a spine model is shown. The spine model 200 is useful for modeling transverse, coronal, and/or sagittal spinal misalignment and training in aligning human spines in need of such alignment. This representative embodiment can be a segment of a more complete model comprising a greater plurality of vertebrae members, wedge members, and discs members. In the embodiment shown in FIG. 9, two vertebrae are shown, a first vertebrae 202 and a second vertebrae 204, each of which are joined to a disc 206, an example of which is shown in more detail in FIG. 10. In the spine model 200 each vertebrae can be sized and shaped to closely resemble an actual human vertebrae, including having portions identified as the vertebral body 208, the spinous process 210, laterally extending transverse processes 212, and a pedicle 214. Further, as shown in FIG. 9, as well as in FIGS. 3-5, at least one pedicle screw receiving port 234 can be disposed at anatomically relevant locations on the pedicle 214. Additionally, the size and shape can be predetermined to model cervical, thoracic (upper and lower) or lumbar vertebrae.

As shown in FIG. 10, the disc 206 can have a first disc face 218 and a second disc face 220, each of which can each be substantially planar, but unlike the disc 106 of the spine model 100, the first disc face 218 and the second disc face 220 lie in non-parallel planes. The first disc face 218 is substantially orthogonal to a first vertebrae axis VA1 that, as depicted in FIG. 9, represents the axis about which the first vertebrae 202 can rotate transversely. Likewise, the second disc face 220 is substantially orthogonal to a second vertebrae axis VA2 that represents the axis about which the second vertebrae 204 can rotate transversely. The first vertebrae axis VA1 and the second vertebrae axis VA2 represent imaginary axes that are non-parallel, but lie in the same plane such that they intersect in the disc 206 and define an angle A2 that correlates to coronal and/or sagittal curvature at the disc 206. For training purposes, the spine model 200 can have an alignment angle A2 that represents one or both of coronal and sagittal misalignment. Thus, when operationally joined, the first vertebrae 202, the disc 206, and the second vertebrae 204 can model a portion of a human spine in need of one or all of transverse derotation, coronal alignment, and sagittal alignment. In an embodiment, the alignment angle A2 can be achieved by use of the multi-curve disc 106A disclosed above. It is understood that angle A2 may be any angle.

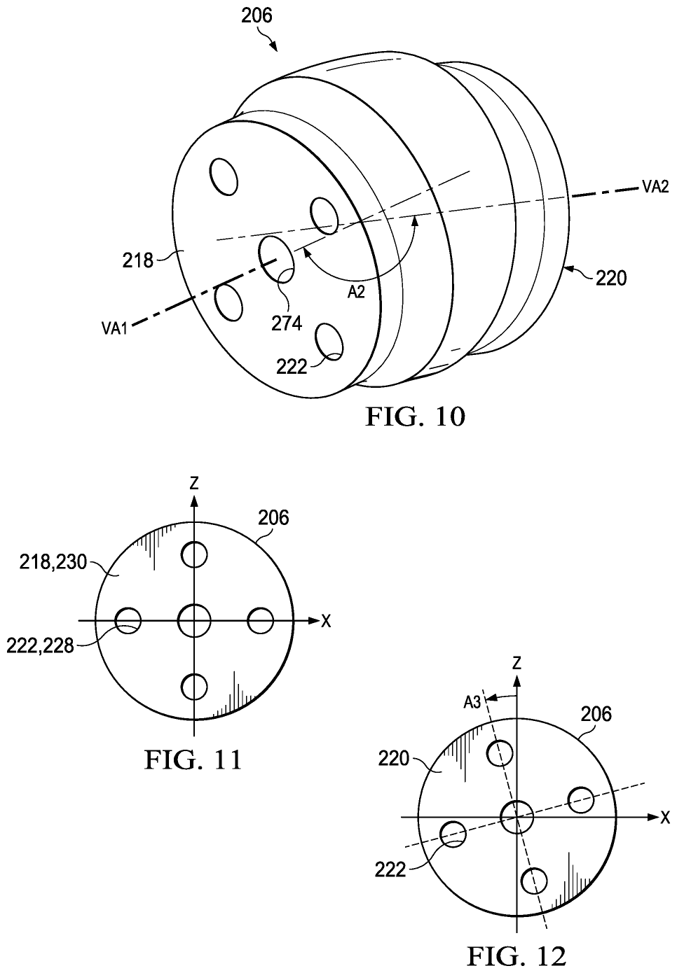

The structure and operating principle of the disc 206 with respect to modeling and training in derotation, including the presence and placement of alignment pins 224 (only one of which is shown in FIG. 9 for clarity) and disc pin-receiving receptacles 222, is the same as described for the disc 106 above. Accordingly, FIG. 11 depicts schematically both or either of (1) the first disc face 218 and the placement and orientation of disc pin-receiving receptacles 222, and (2) one or both of disc-facing surfaces 230 of the first vertebrae 202 and the second vertebrae 204 and orientation of vertebrae pin-receiving receptacles 228. As illustrated, there is depicted an embodiment utilizing four pin-receiving receptacles on each of the depicted surfaces, which can be disc pin-receiving receptacles 222 or vertebrae pin-receiving receptacles 228. That is, for purposes of illustration, FIG. 11 is depicted as being the placement and orientation of the disc pin-receiving receptacles 222 of first disc face 218, and the placement and orientation of the vertebrae pin-receiving receptacles 228 of both the disc-facing surfaces 230 of the first vertebrae 202 and the second vertebrae 204. FIG. 12 depicts schematically the second disc face 220 and the placement and orientation of the disc pin-receiving receptacles 222. As can be understood with reference to the Z-X coordinates, the disc pin-receiving receptacles 222 of the second disc face 220 are oriented at offset angle A3 from those of the first disc face 218. It is understood that angle A3 may be any angle.

As can be understood, therefore, when the first vertebrae 202 having the characteristics described herein is coupled, that is, operationally joined, to the disc 206 with alignment pins 224 engaged with the vertebrae pin-receiving receptacles 228 and the disc pin-receiving receptacles 222 on the first disc face 218, the first vertebrae 202 is then “locked,” rotationally, i.e. unable to rotate about the rotational axis VA1 relative to the disc 206. Likewise, when the second vertebrae 204 having the characteristics described herein is coupled to the disc 206 with alignment pins 124 engaged with the vertebrae pin-receiving receptacles 128 and the disc pin-receiving receptacles 222 on the second disc face 220, the second vertebrae 204 is then “locked,” rotationally, i.e. unable to rotate about the rotational axis VA2 relative to the disc 206.

The spine model 200 can also model coronal and/or sagittal misalignment by the magnitude and orientation of the alignment angle A2. That is, the magnitude of the alignment angle A2 can be sufficient to represent in the model a misalignment in the either or both of the coronal and sagittal plane. Alternatively, the orientation of the alignment angle A2 can be such that the misalignment is fully in one of the coronal plane or the sagittal planes. Further, in an embodiment, the alignment angle A2 can be achieved by use of the multi-curve disc 106A disclosed above.

As with the spine model 100, in the spine model 200 shown in FIG. 9 each of the first vertebrae 202 and the second vertebrae 204 have a disc-facing surface 230 that adjoins the first disc face 218 and the second disc face 220, respectively, when the elements of the spine model 200 are operationally joined (in FIG. 9, the disc-facing surface 230 of the first vertebrae 202 is not showing due to the perspective orientation). On each of the disc-facing surfaces 230 there is at least one corresponding vertebrae pin-receiving receptacle 228. Each of the vertebrae pin-receiving receptacles 228, four of which are on each of the disc-facing surfaces 230 in FIG. 9, can be a generally cylindrical-shaped hole that has a depth sufficient to securely hold the end of an alignment pin 224 during the use of the spine model 200.

As with the spine model 100, the diameter of the first disc face 218 and the second disc face 220 as well as distance separating can be selected to model the corresponding dimensions and/or mechanical properties of a disc of a human spine. Each of the first disc face 218 and the second disc face 220 can have at least one disc pin-receiving receptacle 222 that serves to receive, seat, and/or otherwise secure the end of an alignment pin 224 inserted therein. As shown in FIG. 9, the disc pin-receiving receptacle 222 can be a generally cylindrical-shaped hole that has a depth sufficient to securely hold the end of a cylindrical-shaped alignment pin 224 during the use of the spine model 200. In an embodiment, one or both disc faces can have from two to eight disc pin-receiving receptacles 222. In an embodiment, the alignment pins 224 need not be cylindrical shaped, but can have polygonal cross-sections or irregularly-shaped cross-sections, as long as they serve to enter the relevant pin-receiving receptacles when the vertebrae are operationally joined to the disc. In an embodiment, the alignment pins 224 are 3 mm diameter stainless steel pins having a length of between about ¼ inch and two inches.

In an embodiment, the disc-facing surface 230 of one or both of the first vertebrae 202 and the second vertebrae 204 can be recessed, as indicated in FIG. 9, such that a portion of the disc 206 resides in the recess when the disc and vertebrae are operationally joined. The presence of a recessed disc-facing surface 230 can aid in stabilizing the disc with respect to lateral movement. Such limited movement can aid in the spine model 100 more accurately matching that of a human spine during derotation. As with the disc 106, in an embodiment, each of the first vertebrae 102 and the second vertebrae 104 disc-facing surfaces 130 can have from two to eight vertebrae pin-receiving receptacles 128.

In an embodiment one or both of the first vertebrae 202 and the second vertebrae 204 can have through holes 250, which can be threaded openings, through which a pin, screw, or the like, can be inserted and urged against the outer surface of the disc 206 for added mechanical securement. For example, as depicted in FIG. 9, one or more through holes 250 can be located such that the provide pin or screw securement into the recessed portion of the vertebrae, and, when operationally joined, to the surface of the disc 206 residing in the recessed portion. In an embodiment the through hole 250 is a threaded opening, and a set screw (not shown) can be screwed into pressure contact with the operationally joined disc 206.

When the components of the spine model 200 are operationally joined both vertebrae are in rotationally locked relationship with the disc 206. When the components of the spine model 200 are operationally joined the second vertebrae 204 will be in rotational misalignment with the first vertebrae 202 by an amount equal to the magnitude of the offset angle A3, as depicted in FIG. 12 (which can be, in an example, 0 degrees). Further, when the components of the spine model 200 are operationally joined the second vertebrae 204 will be in one or both of coronal and sagittal curvature relative to the first vertebrae 202. However, because the disc 206 can be made of a flexible material, such as an elastomeric polymer, the second vertebrae 204 can be rotationally urged against the elastomeric forces of the disc 206, including torsional forces, into a position corresponding to proper transverse alignment of a human spine. Further, the second vertebrae can be laterally urged against the elastomeric forces of the disc 206 into a position corresponding to one or both of desired coronal and sagittal alignment. In this manner the spine model 200 can provide for realistic training for derotation and alignment of a human spine in need of derotation and alignment. In an embodiment of the spine model 200, one of the first vertebrae 202 or the second vertebrae 204 can be securely immobilized, for example, by clamping to a training table, to keep it from moving during the derotation and aligning training process.

In an embodiment, a system of the spine model 200 can include two or more vertebrae, one or more discs 206, and a plurality of alignment pins 224. The two or more discs 206 can include discs 206 in which the offset angle A3 for the disc pin-receiving receptacles 222 on the second disc face 220 is varied. In an embodiment, a system of the spine model 100 can include a plurality of discs 206 in which for each disc 206 the offset angle A3 for the disc pin-receiving receptacles 222 on the second disc face 220 can vary in predetermined angular increments, such as increments of 2-5 degrees. The offset angle A3 can be, for example, 5 degrees, 10 degrees, 15 degrees, or 20 degrees.

In a method of use of a system of the spine model 200, a disc 206 having the desired offset angle A3 for the disc pin-receiving receptacles 222 on the second disc face 220 can be selected. The selected disc 206 can then be operationally joined with a first vertebrae 202 and a second vertebrae 204. The second vertebrae 204 can then be urged against the elastomeric force of the disc 206 until the first vertebrae 202 is in desired transverse, coronal, and or sagittal alignment with the second vertebrae 204.

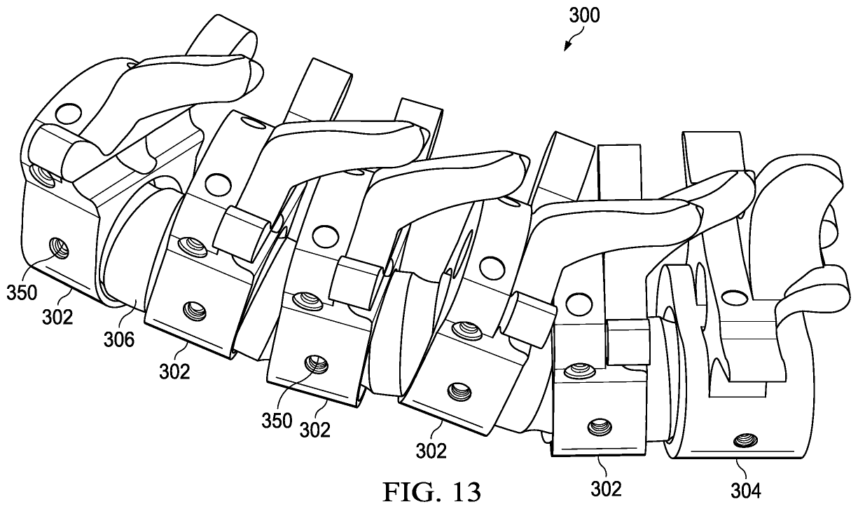

Referring to FIG. 13, a representative example of another embodiment of a spine model is shown. The spine model 300 is useful for modeling transverse, coronal, and/or sagittal spinal misalignment and training in aligning human spines in need of such alignment. This representative embodiment can be a segment of a more complete model comprising a greater plurality of vertebrae members and discs members.

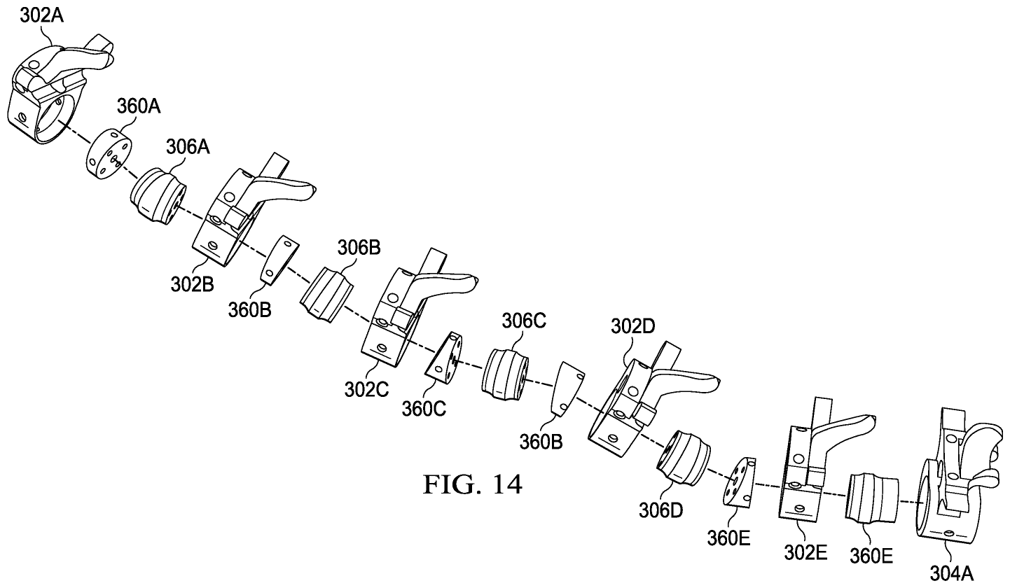

In the embodiment shown in FIG. 13, a segment of the spine is shown in perspective view comprising components more clearly shown in FIG. 14, which is an exploded view of the spine segment shown in FIG. 13. In this example, four lower thoracic vertebrae 302 and a single lumbar vertebrae 304 are shown operationally joined to a plurality of discs 306 and wedges 360 (shown in the exploded view of FIG. 14), described more fully below. As will be understood from the description herein, the spine model 300 offers a range of flexibility in modeling a human spine, including the spine model 300 being arranged to have the identical, or closely similar, curvature of an actual human spine for which the various dispositions of the vertebrae of interest are mapped, i.e., quantified in terms of placement and angular relationship.

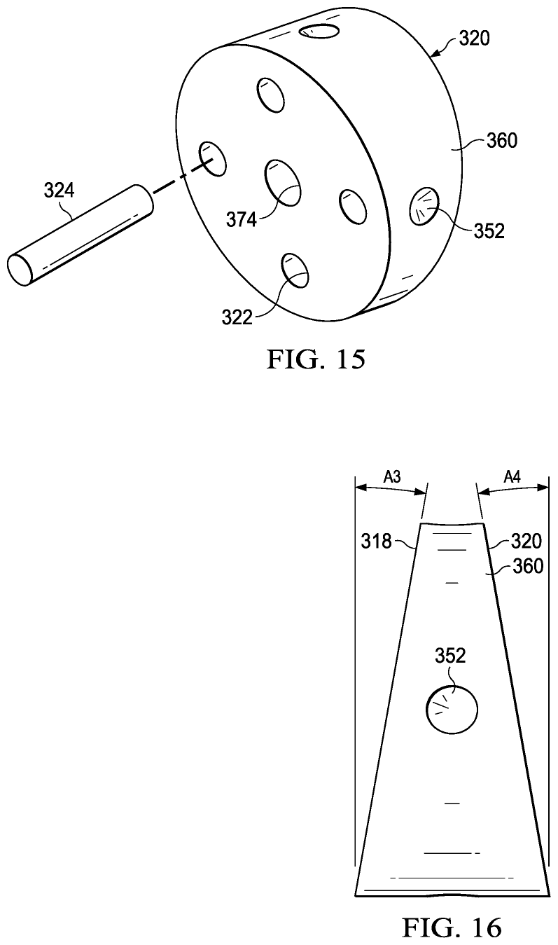

The spine model 300, in addition to one or more discs 306, which can be identical in structure and operation as the disc 106 or disc 206 described above, there is provided one or more wedges 360. A representative example of a wedge 360 is depicted in perspective view in FIG. 15, and in side view in FIG. 16. As depicted, the wedge 360 can have a similar structure to a disc, including being generally circular in shape and having one or more disc pin-receiving receptacles 322 for the securement of alignment pins 324, one of which is shown in FIG. 15. A wedge 360 can have a first face 318 and a second face 320, each of which can be generally planar, with the plane of the first face 318 being non-parallel to the plane of the second face 320. That is, as depicted in FIG. 16, the first face 318 can have an inclination is a side view, the inclination defining an angle A3. Likewise, the second face 320 can have an inclination in a side view, the inclination defining an angle A4. In various examples, both angle A3 and angle A4 can be greater than 0 degrees. In an embodiment, one of the angle A3 and the angle A4 can be 0 degrees. Angles A3 and A4 can have the same or different angles from each other. It is understood that angle A4 can be any angle. As will be understood, the operational joining of the wedge 360 is achieved the same as described above with respect to discs, and the result is likewise the same: when the wedge 360 is operationally joined between a disc and vertebrae, or between two vertebrae, the so-coupled vertebrae and/or disc is rotationally locked. Thus, to model and implement two curves within the same intervertebral part, a wedge can be added so that one curve (sagittal or coronal) is accounted for in the disc, and the other is accounted for in the wedge. Rotation of each part allows for the freedom to choose which part accounts for which deformity. Therefore, the wedge is not strictly limited to modeling the sagittal curve, and the disc is not limited to only modeling the coronal curve.

Referring now to FIG. 14, the example spine model 300 is shown in exploded view. This example is representative only, as will become clear from the description herein, virtually any combination of vertebrae, discs, and wedges can be implemented in the spine model 300 to produce the desired curvature of the spine model 300. As shown in FIG. 14, moving from left to right, the spine model 300 includes a first lower thoracic vertebrae 302A; a first wedge 360A in which the sum of the angle A3 and angle A4 is 10 degrees and referred to as a “10-degree wedge.” In general, for wedges of “N” degrees, the wedge the angle A3 can be 0 degrees and the angle A4 can be N degrees. Likewise, in an N-degree wedge, the angle A3 and the angle A4 can be greater than 0 degrees and sum to N degrees. Continuing to describe the exploded view of FIG. 14, there is a first disc 306A that can be the same in structure as the above-described disc 206, including having a varied outer diameter and having an angle A2, which in the illustrated embodiment is an angle of 20 degrees, arranged to achieve a 20 degree coronal curve, referred to as a “20 degree coronal varied diameter disc;” a second lower thoracic vertebrae 302B; a second wedge 360B, also being a 10-degree wedge; a second disc 306B having an angle A2 of 5 degrees; a third lower thoracic vertebrae 302C; a third wedge 360C which is a 20-degree wedge; a third disc 306C which has an angle A2 of five degrees; a fourth wedge 360D with is a 20-degree wedge in which the angle A3 is 0 degrees, i.e., a “20-degree wedge, one side;” a fourth lower thoracic vertebrae 302D; a fourth disc 306D which is a 10-degree coronal varied diameter disc; a fifth wedge 360E, which is a 20-degree wedge, one side; a fifth lower thoracic vertebrae 302E; a fifth disc 306E, which is 5-degree transition disc, as it transitions to the first lumbar vertebrae 304A.

Further, with reference to FIGS. 13 and 14, one or more of the vertebrae 302 can have can have through holes 350, which can be threaded openings, through which a pin, screw, or the like, can be inserted and urged against the outer surface of the disc 306 or the wedge 360, depending on which element resides in a recessed face of the relevant vertebrae, for added mechanical securement. For example, as depicted in FIG. 13, one or more through holes 350 can be located such that the provide pin or screw securement into the recessed portion of the vertebrae, and, when operationally joined, to the surface of the disc 306 or wedge 360 residing in the recessed portion. In an embodiment, the disc or wedge can have one or more corresponding indentations 352 into which the pin or screw can engage. In an embodiment the through hole 350 is a threaded opening, and a set screw (not shown) can be screwed into pressure contact with the operationally joined disc 306, for example, at the indentation 352.

In an embodiment, a system of the spine model 300 can include two or more vertebrae, one or more discs 306, one or more wedges 360, and a plurality of alignment pins 324. The two or more discs 306 can include discs 306 in which the offset angle, i.e., as described for the offset angle A3 above, for the disc pin-receiving receptacles 322 on the second face 320 is varied. In an embodiment, a system of the spine model 100 can include a plurality of discs 306 in which for each disc 306 the offset angle A3 for the disc pin-receiving receptacles 322 on the second disc face 320 can vary in predetermined angular increments, such as increments of 2-5 degrees. The offset angle A3 can be, for example, 5 degrees, 10 degrees, 15 degrees, or 20 degrees.

As can be understood from the description herein, the spine model 300 provides for essentially limitless variation in the curvature of the spine in the model, including variation in the transverse, coronal and sagittal planes. Thus, in a method of use of a system of the spine model 300, a disc 306 having the desired offset angle A3 for the disc pin-receiving receptacles 322 on the second disc face 320 can be selected. A wedge 360 having the desired wedge angle, that is, angle A3 and/or angle A4, can be selected. The selected disc(s) 306 and selected wedge(s) 360 can then be operationally joined with a one or more vertebrae to produce a multi-vertebrae spine having curvature in one or all of the transverse, coronal, and sagittal planes. Selected vertebrae can then be urged against the elastomeric force of the disc(s) 306 and/or wedge(s) 360 until the vertebrae of interest are in desired transverse, coronal, and or sagittal alignment.

In an embodiment, one or more of the intervertebrae joint components shown in FIG. 14, e.g., the discs and wedges, can be replaced in whole or in part, with the multi-curve disc 106A, disclosed above.

### EXAMPLES

Representative examples of spine models 300 are illustrated below. The examples are non-limiting, and illustrate how a spine model 300 can be achieved that closely matches an actual human spine. In the examples below, the associated Tables indicate the quantified angular orientation of intervertebrate joint angles in degrees, which is the angle made between adjacent vertebrae. The adjacent vertebrae are listed in one column by number, such as “T1T2” which indicates the angle in that row of the table is the angle between a first and second thoracic vertebrae. The listed angles are understood to be based on the two-dimensional angles of each orthogonal coronal or sagittal planes. In an embodiment, the angles can be built into a multi-curve disc 106A, as discussed above. In an embodiment, the angles can be the result of a disc having the listed angle that is illustrated herein as angle A2 in FIG. 10, or the result of a wedge having the listed angle that is illustrated as one, or the sum of, the angles A3 and A4 in FIG. 16, or the result of a disc and wedge that together produce the listed angle.

### Example 1

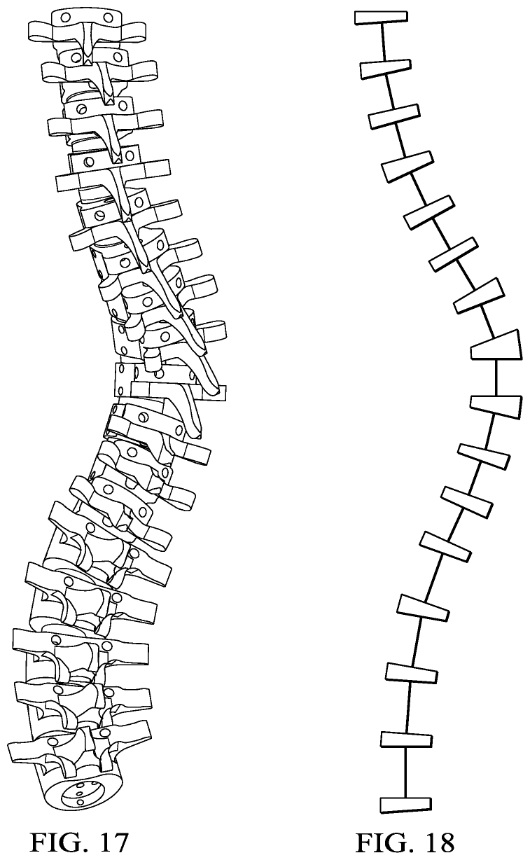

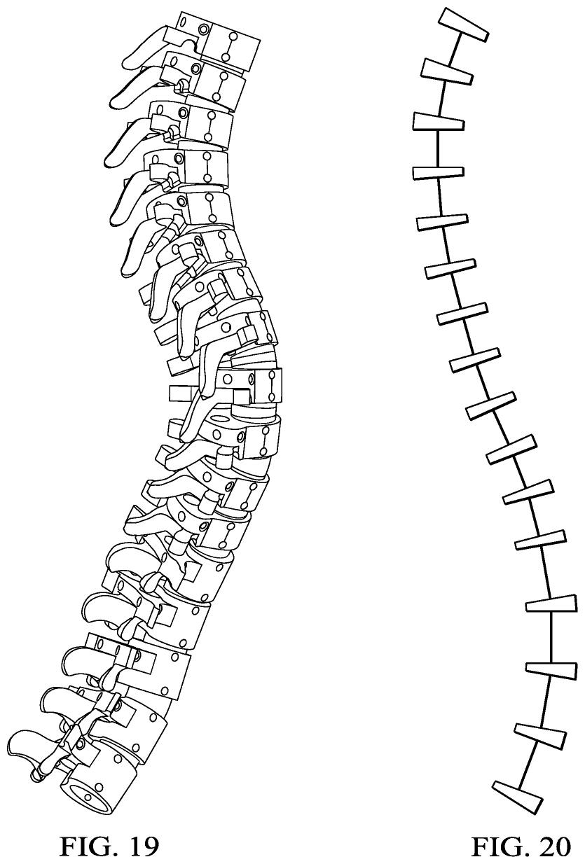

Example 1 models a Type 1 deformity in which the spine contains a single structural main thoracic curve with possible nonstructural proximal and thorocolumbar/lumbar curves. FIGS. 17 and 18 show the spinal curvature in the coronal plane as a 3-D model and in a 2D disc sketch, respectively. FIGS. 19 and 20 show the spinal curvature in the sagittal plane as a 3-D model and in a 2D disc sketch, respectively. This spine model can be achieved according to Table 1 below.

TABLE 1
Intervertebral Angles of Example 1

| Level | Coronal | Sagittal | Derotation |
|---|---|---|---|
| Horizontal | 0 | −20 | 0 |
| T1T2 | −5 | 0 | −10 |
| T2T3 | −5 | 10 | 0 |
| T3T4 | −5 | 10 | 0 |
| T4T5 | −10 | 5 | 0 |
| T5T6 | −5 | 10 | −10 |
| T6T7 | 0 | 5 | −10 |
| T7T8 | 10 | 0 | −10 |
| T8T9 | 20 | −5 | 10 |
| T9T10 | 15 | 5 | 10 |
| T10T11 | 5 | −15 | 0 |
| T11T12 | 5 | 5 | 5 |
| T12L1 | −5 | −5 | 0 |
| L1L2 | −10 | 0 | 5 |
| L2L3 | −5 | 0 | 5 |
| L3L4 | −5 | −15 | 0 |
| L4L5 | −5 | −5 | 5 |

### Example 2

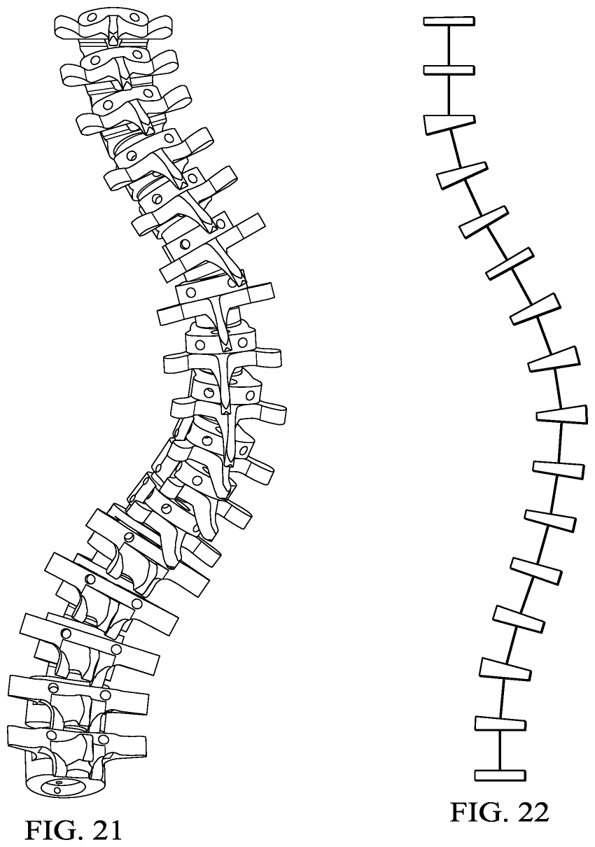

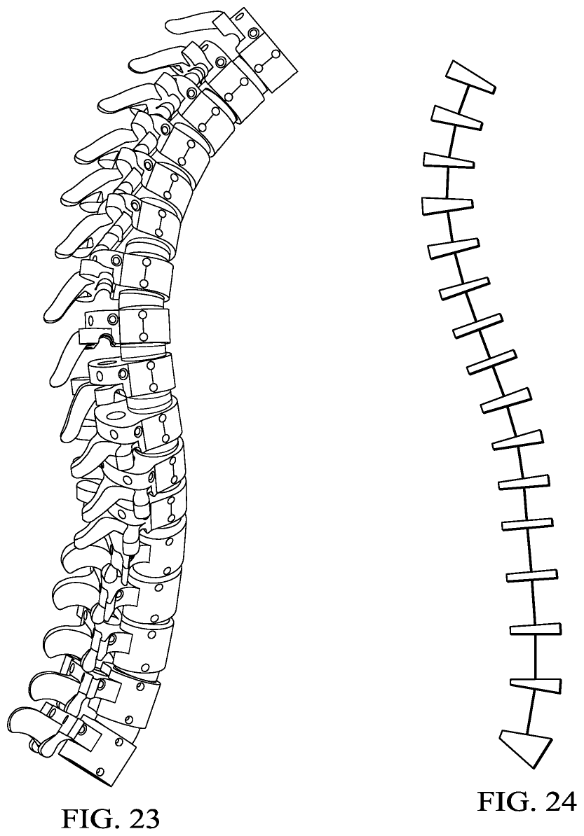

Example 2 models a Type 2 deformity in which the spine contains a double thoracic curve with the main thoracic curve being the major curve. The proximal and main thoracic curves are structural while the thorocolumbar/lumbar curve is nonstructural. FIGS. 21 and 22 show the spinal curvature in the coronal plane as a 3-D model and in a 2D disc sketch, respectively. FIGS. 23 and 24 show the spinal curvature in the sagittal plane as a 3-D model and in a 2D disc sketch, respectively. This spine model can be achieved according to Table 2 below.

TABLE 2
Intervertebral Angles of Example 2

| Level | Coronal | Sagittal | Derotation |
|---|---|---|---|
| Horizontal | 0 | −45 | 0 |
| T1T2 | −10 | 5 | 0 |
| T2T3 | −10 | 5 | 0 |
| T3T4 | −10 | 10 | 0 |
| T4T5 | −5 | 5 | 0 |
| T5T6 | 0 | 10 | 0 |
| T6T7 | 15 | 5 | 0 |
| T7T8 | 10 | 10 | 0 |
| T8T9 | 10 | 5 | −10 |
| T9T10 | 15 | 5 | −10 |
| T10T11 | 10 | 0 | −10 |
| T11T12 | 5 | 0 | 10 |
| T12L1 | 0 | −5 | 10 |
| L1L2 | −5 | −5 | 10 |
| L2L3 | −10 | −5 | 0 |
| L3L4 | −10 | −10 | 0 |
| L4L5 | −5 | −15 | 0 |

### Example 3

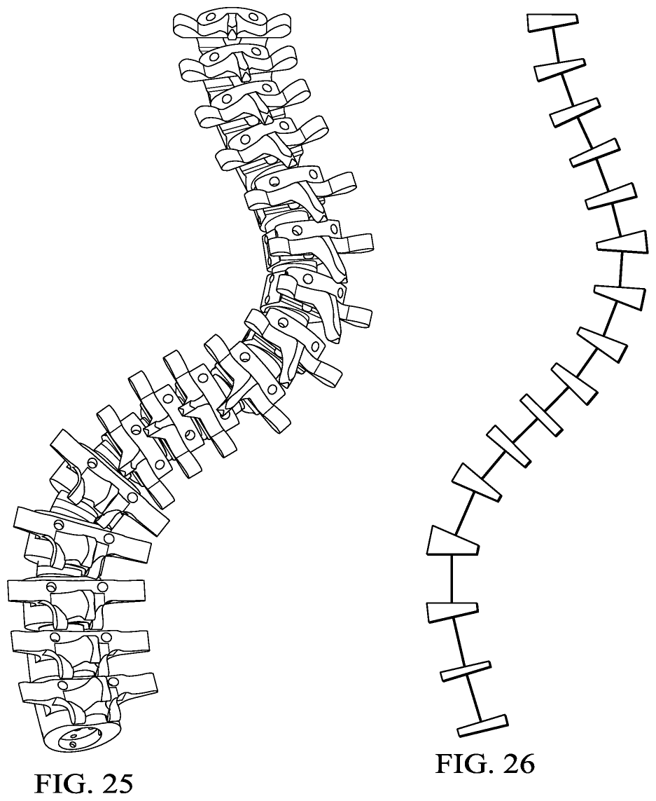

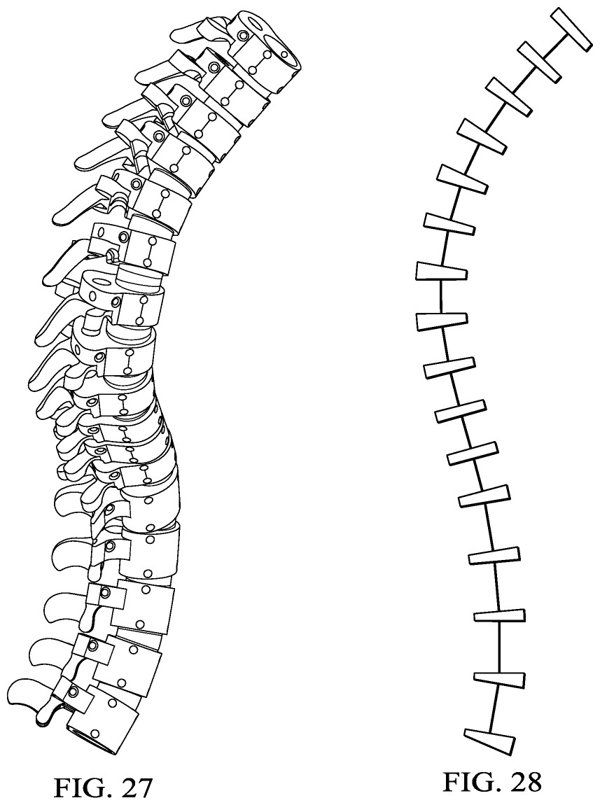

Example 3 models a Type 3 deformity in which the spine contains a double curve with the main thoracic curve being the major curve and the thorocolumbar/lumbar curve is the minor curve. The thorocolumbar/lumbar and main thoracic curves are structural while the proximal thoracic curve is nonstructural. FIGS. 25 and 26 show the spinal curvature in the coronal plane as a 3-D model and in a 2D disc sketch, respectively. FIGS. 27 and 28 show the spinal curvature in the sagittal plane as a 3-D model and in a 2D disc sketch, respectively. This spine model can be achieved according to Table 3 below.

TABLE 3
Intervertebral Angles of Example 3

| Level | Coronal | Sagittal | Derotation |
|---|---|---|---|
| Horizontal | 0 | −45 | 0 |
| T1T2 | −10 | 5 | 0 |
| T2T3 | −10 | 5 | 0 |
| T3T4 | −5 | 5 | 0 |
| T4T5 | 5 | 10 | −10 |
| T5T6 | 5 | 10 | −10 |
| T6T7 | 20 | 5 | −10 |
| T7T8 | 15 | 10 | 10 |
| T8T9 | 15 | 10 | 10 |
| T9T10 | 10 | 5 | 10 |
| T10T11 | 0 | 0 | 0 |
| T11T12 | −5 | 0 | 0 |
| T12L1 | −15 | −5 | 0 |
| L1L2 | −25 | −5 | 0 |
| L2L3 | −15 | −5 | 0 |
| L3L4 | 0 | −10 | 0 |
| L4L5 | 5 | −10 | 0 |

### Example 4

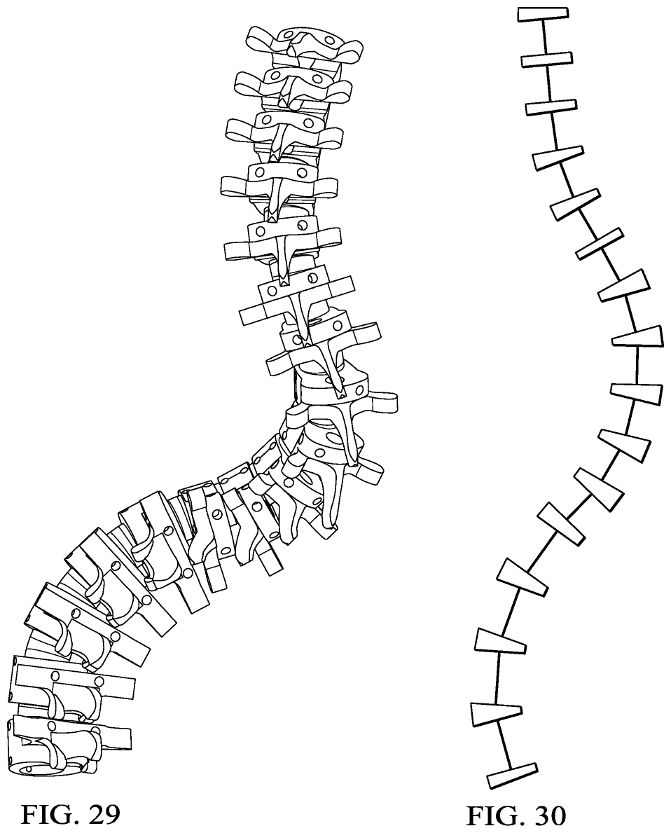

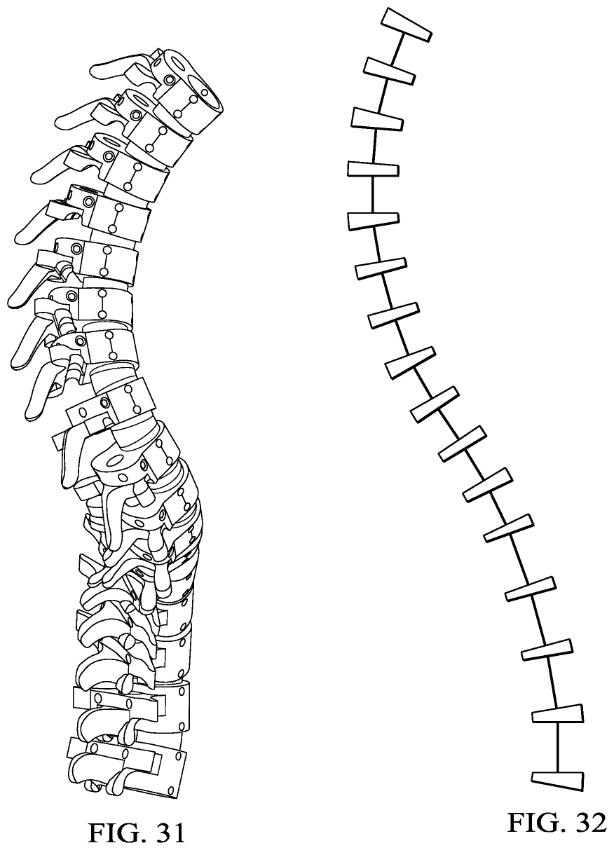

Example 4 models a Type 4 deformity that consists of a main structural thoracic curve with structural proximal thoracic and thorocolumbar/lumbar curves. FIGS. 29 and 30 show the spinal curvature in the coronal plane as a 3-D model and in a 2D disc sketch, respectively. FIGS. 31 and 32 show the spinal curvature in the sagittal plane as a 3-D model and in a 2D disc sketch, respectively. This spine model can be achieved according to Table 4 below.

TABLE 4
Intervertebral Angles of Example 4

| Level | Coronal | Sagittal | Derotation |
|---|---|---|---|
| Horizontal | 10 | −45 | 0 |
| T1T2 | −5 | 10 | 0 |
| T2T3 | 0 | 10 | 0 |
| T3T4 | −5 | 10 | 0 |
| T4T5 | −10 | 10 | 0 |
| T5T6 | −10 | 10 | 0 |
| T6T7 | 0 | 10 | −10 |
| T7T8 | 15 | 15 | −10 |
| T8T9 | 20 | 15 | −10 |
| T9T10 | 20 | 5 | 10 |
| T10T11 | 20 | 0 | 10 |
| T11T12 | 15 | 0 | 10 |
| T12L1 | −10 | −5 | 0 |
| L1L2 | −15 | −5 | 0 |
| L2L3 | −15 | −10 | 0 |
| L3L4 | −20 | −10 | 0 |
| L4L5 | 5 | −15 | 0 |

### Example 5

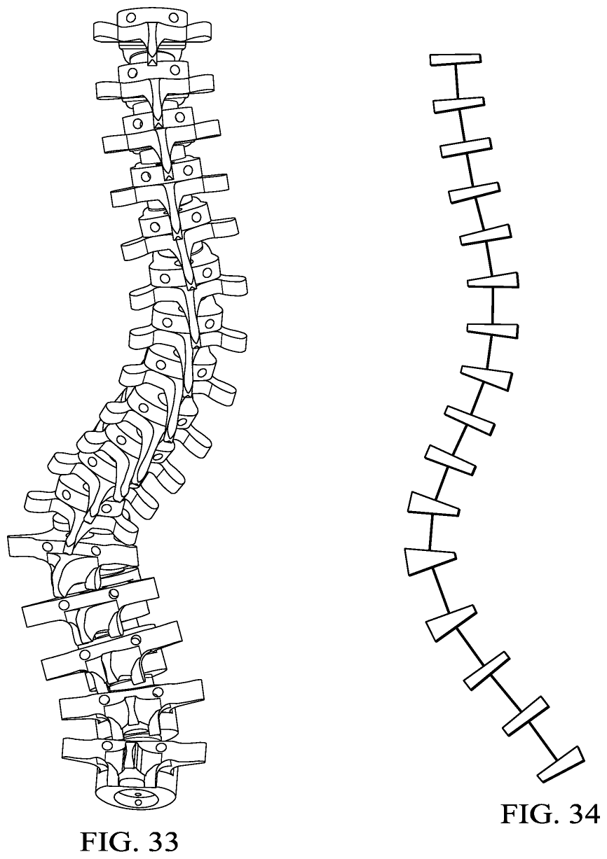

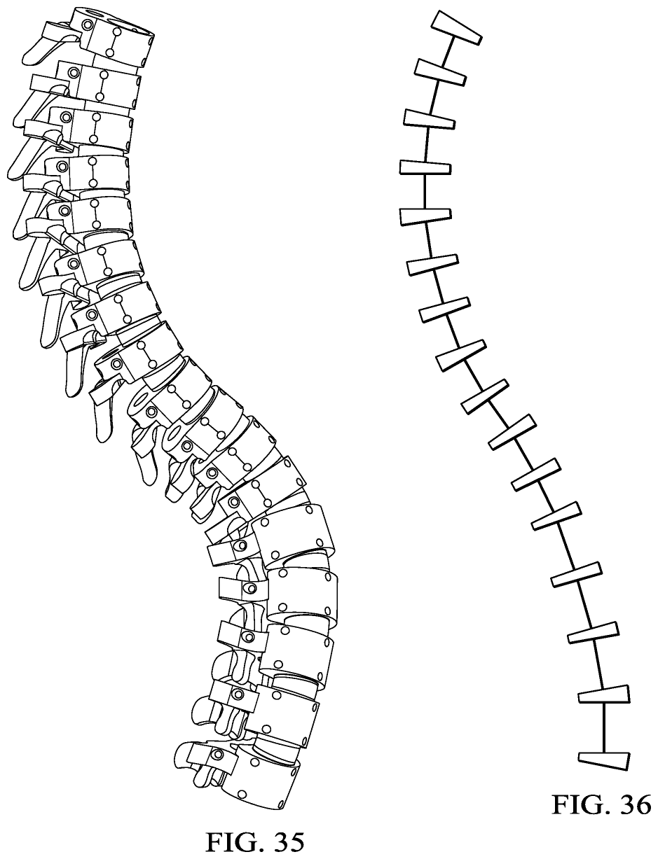

Example 5 models a Type 5 deformity that consists of a main structural thoracic curve with structural proximal thoracic and thorocolumbar/lumbar curves. FIGS. 33 and 34 show the spinal curvature in the coronal plane as a 3-D model and in a 2D disc sketch, respectively. FIGS. 35 and 36 show the spinal curvature in the sagittal plane as a 3-D model and in a 2D disc sketch, respectively. This spine model can be achieved according to Table 5 below.

TABLE 5
Intervertebral Angles of Example 5

| Level | Coronal | Sagittal | Derotation |
|---|---|---|---|
| Horizontal | 0 | −20 | 0 |
| T1T2 | −5 | 10 | 0 |
| T2T3 | −5 | 5 | 0 |
| T3T4 | 0 | 10 | 0 |
| T4T5 | −5 | 5 | 0 |
| T5T6 | 5 | 10 | 0 |
| T6T7 | 10 | 5 | 0 |
| T7T8 | 10 | 5 | 0 |
| T8T9 | 10 | 10 | 0 |
| T9T10 | 5 | 5 | 0 |
| T10T11 | −5 | −5 | −10 |
| T11T12 | −15 | −5 | −10 |
| T12L1 | −20 | −5 | −10 |
| L1L2 | −15 | −10 | 10 |
| L2L3 | −5 | −10 | 10 |
| L3L4 | 5 | −10 | 10 |
| L4L5 | 10 | −10 | 0 |

### Example 6

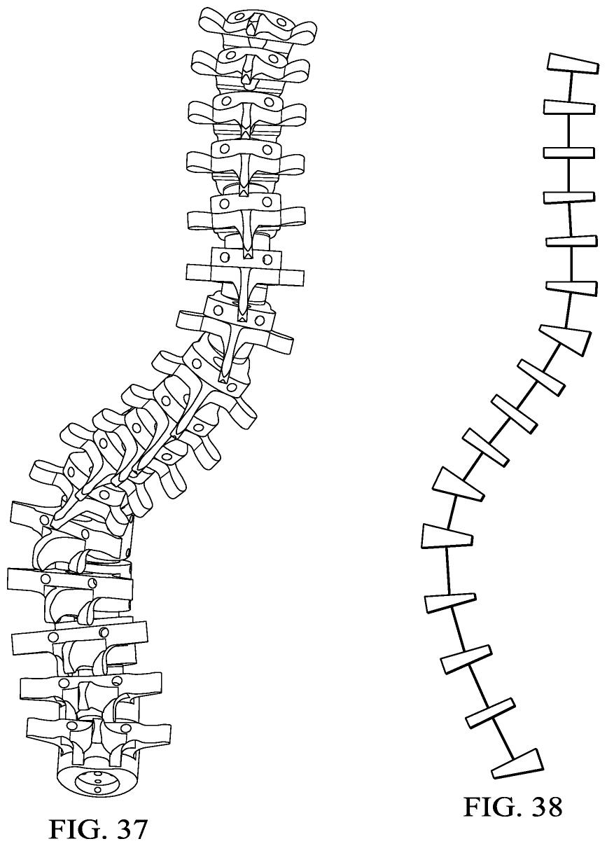

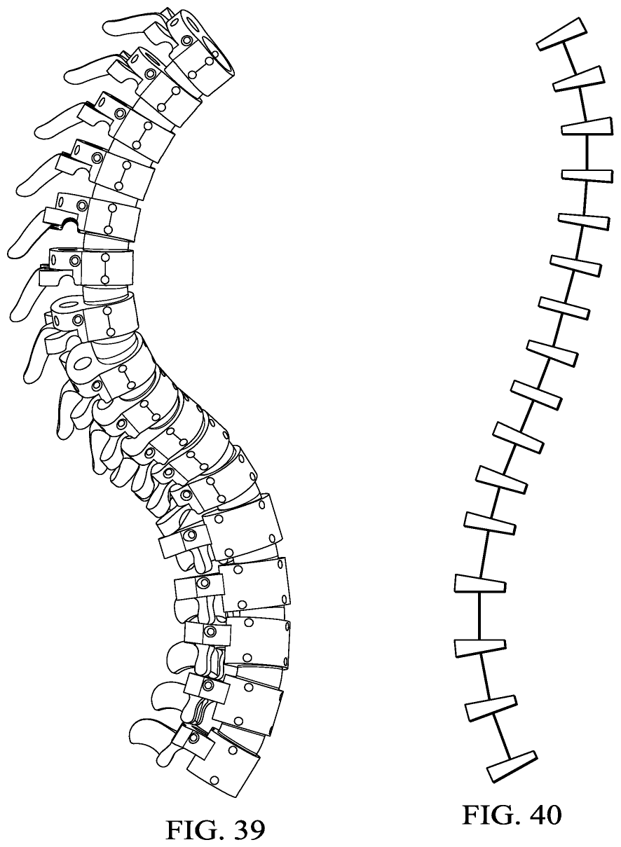

Example 6 models a Type 6 deformity that consists of a main structural thorocolumbar/lumbar curve and a structural thoracic curve with the thorocolumbar/lumbar curve being the main curve. FIGS. 37 and 38 show the spinal curvature in the coronal plane as a 3-D model and in a 2D disc sketch, respectively. FIGS. 39 and 40 show the spinal curvature in the sagittal plane as a 3-D model and in a 2D disc sketch, respectively. This spine model can be achieved according to Table 6 below.

TABLE 6
Intervertebral Angles of Example 6

| Level | Coronal | Sagittal | Derotation |
|---|---|---|---|
| Horizontal | −10 | 50 | 0 |
| T1T2 | −5 | 10 | 0 |
| T2T3 | −5 | 10 | 0 |
| T3T4 | 0 | 10 | 0 |
| T4T5 | −5 | 10 | 0 |
| T5T6 | 5 | 10 | 0 |
| T6T7 | 10 | 10 | 0 |
| T7T8 | 20 | 15 | 0 |
| T8T9 | 5 | 10 | 0 |
| T9T10 | 5 | 5 | 0 |
| T10T11 | −5 | 0 | −10 |
| T11T12 | −20 | −5 | −10 |
| T12L1 | −20 | −5 | −10 |
| L1L2 | −10 | −5 | 10 |
| L2L3 | −10 | −5 | 10 |
| L3L4 | 0 | −15 | 10 |
| L4L5 | 0 | −15 | 0 |

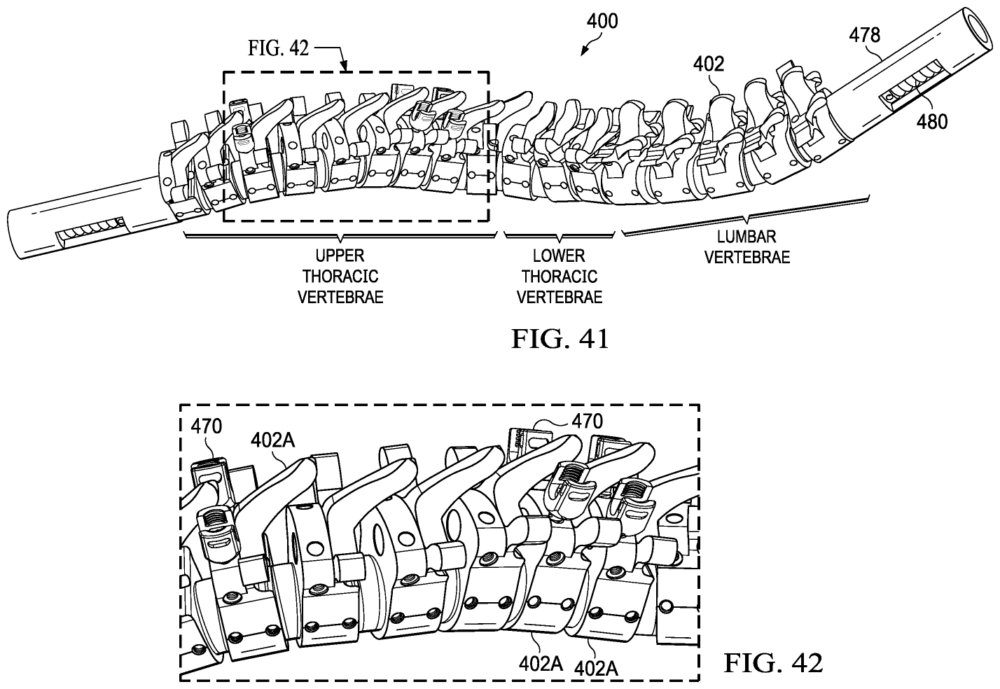

Referring to FIG. 41, a representative example of another embodiment of a spine model is shown. The spine model 400 is useful for modeling transverse, coronal, and/or sagittal spinal misalignment and training in aligning human spines in need of such alignment. This representative embodiment can include any and all of the previously described components, with the structure, function, and benefits being the same and not repeated in this embodiment.

The spine model 400 can include a plurality of discs, wedges, and vertebrae, as described above, in a combination arranged in a configuration to match that of a desired segment of a human spine. That is, as depicted in FIG. 41, the vertebrae 402 can be arranged in number and placement to include the upper thoracic vertebrae, the lower thoracic vertebrae, and the lumbar vertebrae.

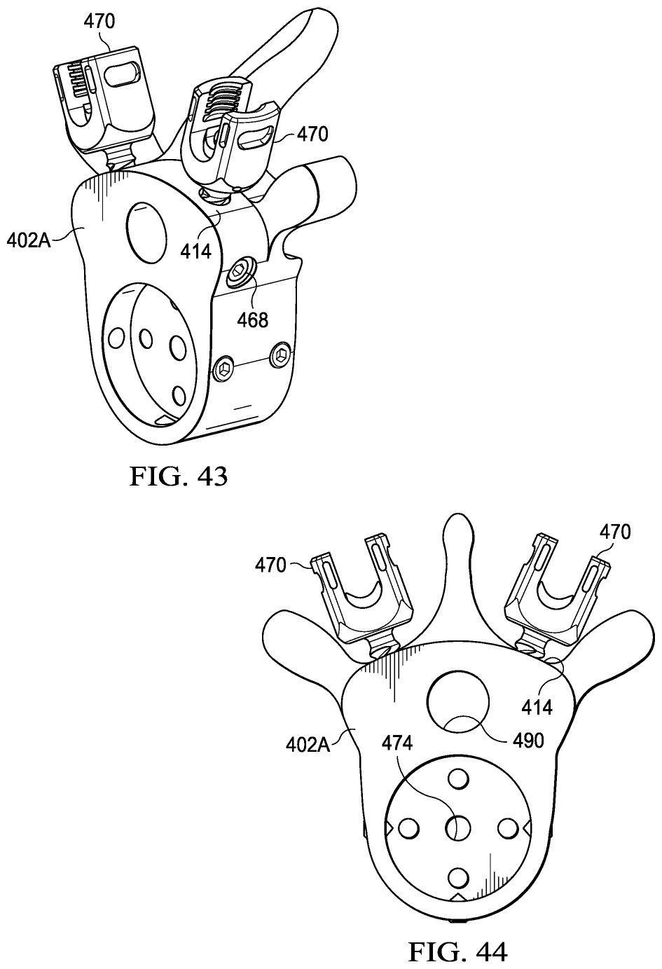

The spine model 400 also includes certain features that enhance the spine models modelling and training benefit. For example, as shown in the enlarged inset image 42 of FIG. 41 in FIG. 42, one or more of the vertebrae 402 can have pedicle screws 470 attached thereto. In the example, each of the vertebrae identified as 402A have two pedicle screws 470 joined at the pedicle. The pedicle screws 470 are shown in more detail in FIGS. 43 and 44. The pedicle screws 470 can be any of the type of pedicle screws known for spinal rod affixation. In an embodiment, the pedicle screws 470 are joined, such as be epoxy, adhesive, or the like, into pedicle screw receiving port 434, which is shown as pedicle screw receiving port 234 in FIG. 9. That is, the vertebrae can have an opening, such as a cylindrical hole on the pedicle 414 into which the shank of a pedicle screw can be inserted and secured. In an embodiment, a pedicle screw 470 can be screwed into the vertebrae. In an embodiment, as shown in FIG. 43, the pedicle screw 470 can be inserted into the pedicle screw receiving port 434 and secured by a set screw 468, screwed from the side of the pedicle.

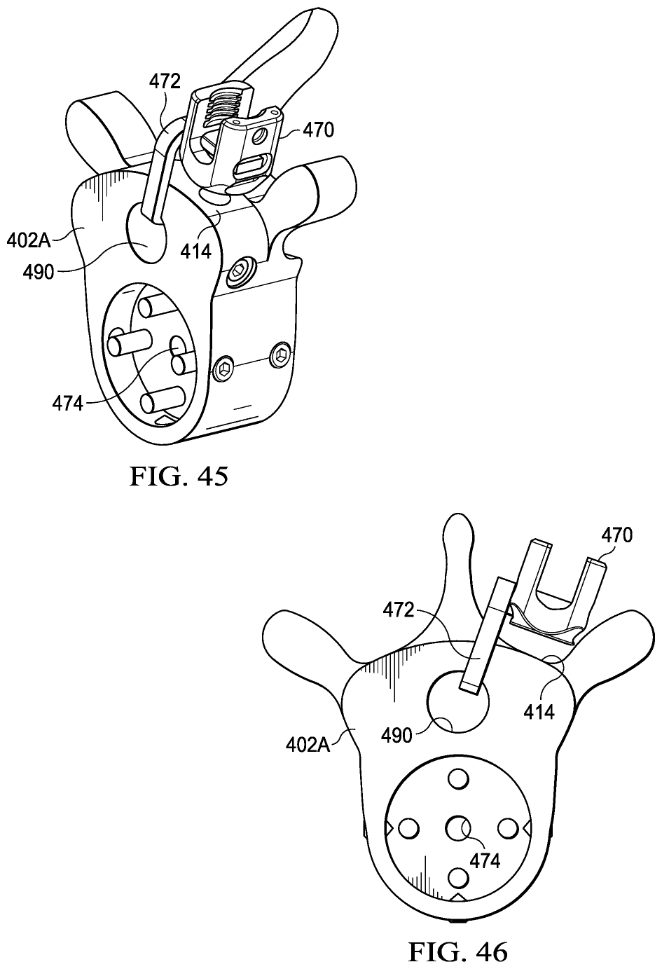

In an embodiment, as shown in FIGS. 45 and 46, a pedicle screw 470 can be mechanically joined to the vertebrae 402A. For example, a pedicle-sparing fixation band 472, such as a BandLoc sub-laminar polyester band from OrthoPediatrics, Warsaw, Ind. can join the tulip head of a pedicle screw via banding to the spinal canal 490 of the vertebrae. Alternatively, a clamp member (not shown) can mechanically position and secure the pedicle screw 470 to the pedicle 414. In an embodiment one portion of the clamp member engages the pedicle screw head and another portion of the clamp member engages a portion of the vertebrae, as shown in FIG. 45.

Further with respect to the spine model 400, the model can utilize a spring-wire system for tensioning the vertebrae. For example, a tensioning wire 476, can be strung through each vertebrae, disc, and wedge, such as through a central aperture of each, such as a vertebrae central aperture 474, shown in FIGS. 43-46. A similar central aperture can be utilized in discs, such as disc central aperture 274, shown in FIG. 10. A similar central aperture can be utilized in wedges, such as wedge central aperture 374, shown in FIG. 15. The tensioning wire 476 can be secured at each end of the spine model 400 in a spring housing 478. The spring housing 478 houses a spring 480 that is mechanically coupled to the tensioning wire 476 to permit tensioning of the tensioning wire 476.

The system and method of the spine model 400 can be utilized and practiced to simulate the anatomy and mechanics of a spine, including a pediatric spine, and can be manipulated to form various deformities. The spine model 400 is assembled by sequentially stringing all components on the tensioning wire 476 and pinning and screwing these components together as they are added, with alignment pins and set screws being utilized above as described above with respect to the spine models 100, 200, and 300. The alignment pins hold the vertebrae and discs together in addition to transferring torque and some of the bending forces to the intervertebral discs. The set screws hold the discs in place to avoid axial movement when forces are applied.

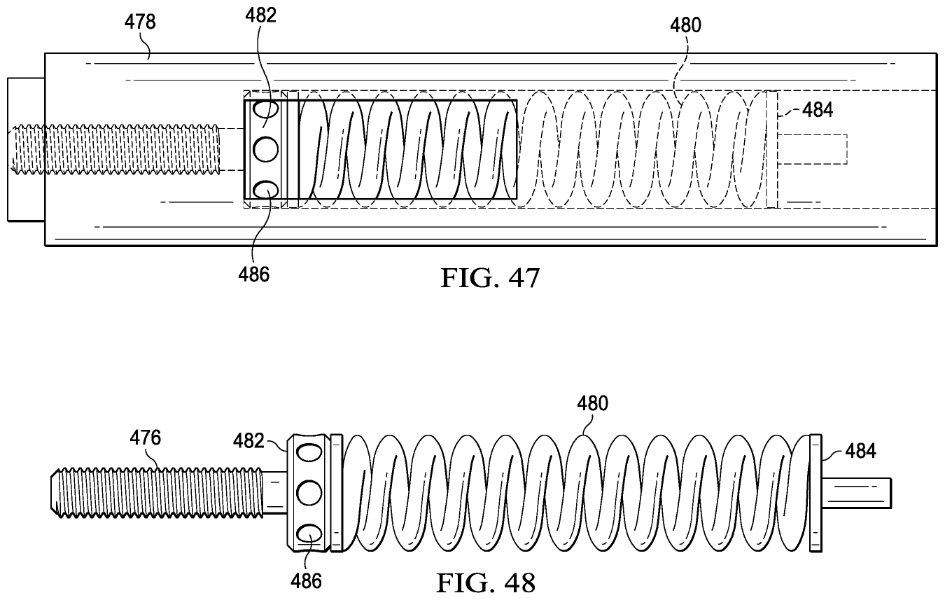

Once all components are added onto the tensioning wire 476, the tensioning wire 476 is tensioned. With reference to FIGS. 47 and 48, tensioning is accomplished by rotating the tensioning bolt 482 on one or both ends in a direction such that the bolt applies a compression force the spring 480, which compresses due to the end constraint component 484, which can be a crimp on the tensioning wire 476. One or more holes 486 on the tensioning bolt 482 can be utilized to aid in rotating the tensioning bolt 482. For example, holes 486 permit a screw driver, hex key, or the like to be inserted and utilized to increase the moment of torque on the tensioning bolt 482. The force in the compressed spring is transferred to the end constraint component 484 on the wire, tensioning the tensioning wire 476. Therefore, the more the tensioning bolt 482 is rotated to compress the spring 480, the higher the tension in the tensioning wire 476. Increasing this tension creates a greater bending resistance in the sagittal and coronal planes. The increased tension can put a greater compressive residual stress in the discs, increasing the force for further bending-induced compression on the discs, and bending the spine may involve increasing the length of the wire in the spine, which could require performing work on the spring. The rest of the bending resistance can be provided by the disc material. The disc material can also provide resistance to derotation.

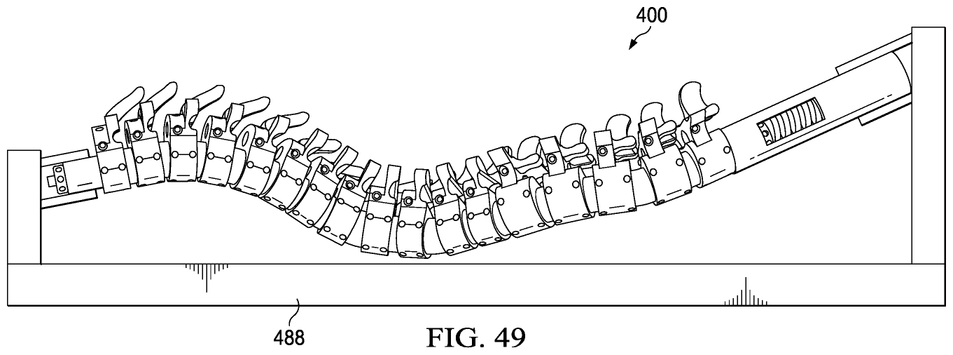

After the wire is tensioned, the spring housing 478 which house the spring 480 system can be immobilized, such as by being clamped into a test frame 488, as shown in FIG. 49. Immobilizing the ends of the spine model 400 can aid in testing. The vertebrae are designed with holes designated for pedicle screws, and these pedicle screws can be securely held in place by set screws so that the vertebrae can be reused (unlike traditional foam spine models that become damaged as a screw shank is placed). A spinal fusion rod (not shown) can be used, such as by reducing the spinal fusion rod into the heads of the pedicle screws, and the curvature of the spine of the spine model 400 can be aligned as would a similarly curved human spine. A variety of implants and instruments known in the art of spinal fusion can be used on the spine model 400. A spinal canal 490 is also simulated so that sublaminar bands/wires can be placed.

In a method of use, the spine model 400 can be used in a myriad of ways. A user can 3D print desired discs and/or wedges, and can assemble a library of discs of various types that may be included in a spine model kit. As the components are assembled, the order and orientation of the discs will determine what the overall curve of the spine model 400 will be. The spine model 400 can then be set in the test frame 488 and the vertebrae can be aligned in a similar manner as would a human spine, and, in particular, a pediatric spine.

In an embodiment, a human spine can be imaged, analyzed, and duplicated in the spine model 400, such that the curvature of the human spine is duplicated in the spine model 400. The overall curve of the human spine is mapped out and broken up into curves for each individual vertebra, and these curves can be duplicated, or closely approximated in the spine model 400. This concept can consist of using CT scans to manufacture patient-specific models more accurately. The CT scans can be converted into CAD models for both the vertebrae and the intervertebral discs and/or wedges. Using this method ensures the true anatomy of the patient is modeled. Once the dimensional criteria are established, the various components of the spine model can be manufactured by machining, 3D printing, molding, and the like.

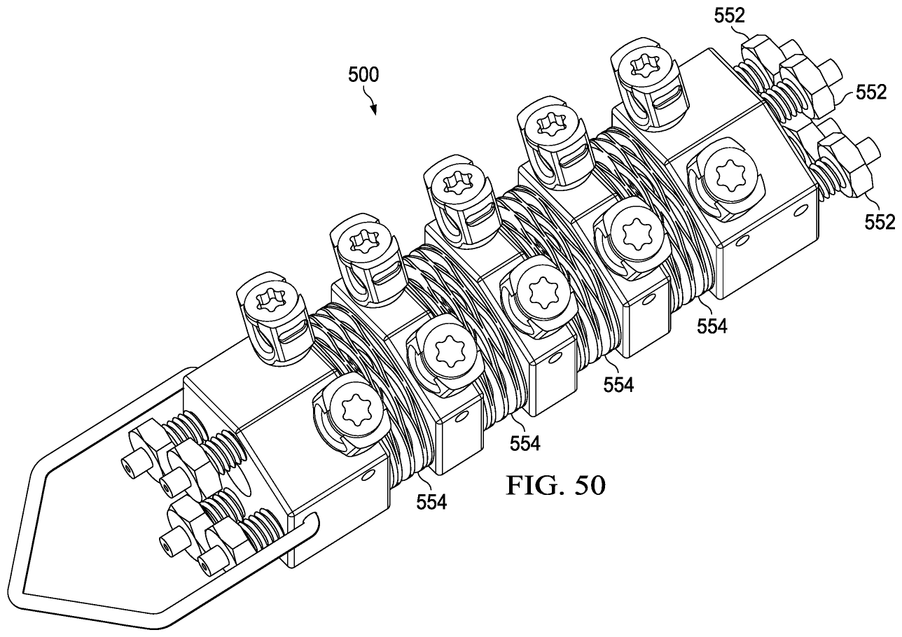

Referring to FIG. 50, a representative example of another embodiment of a spine model is shown. The spine model 500 is useful for modeling transverse, coronal, and/or sagittal spinal misalignment and training in aligning human spines in need of such alignment. This representative embodiment can be a segment of a more complete model comprising a greater plurality of vertebrae members and discs members.

In the spine model 500, instead of having one tensioning wire running through the model there can be multiple (e.g., four tensioning wires), opposing tensioning wires 552 that are offset from the centerline, running through different intervertebral components such as discs, wedges, or springs. Individual adjustment of the tension of each wires can change the shape of the sagittal and coronal curves of the spine model 500. Manipulating the available wire for each of the individual wires by either loosening or tightening the bolts changes the model's resistance to sagittal and coronal bending The wires can be adjusted to lengths that will cause the model to have bending resistance representative of a spine.

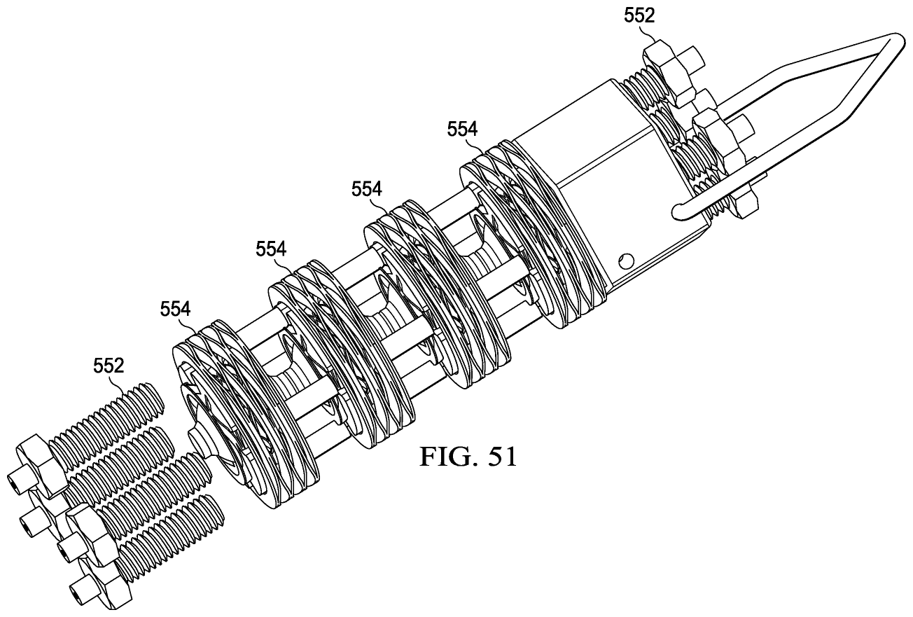

In an embodiment, as shown in FIG. 50, the spine model 500 can include wave spring 554, as depicted in more detail in the view of the spine model 500 in FIG. 51 in which certain components are removed to expose a view to the wave springs 554. The wave springs 554 can be CMS40-M4 wave springs from Smalley, Lake Zurich, Ill. The wave springs 554 can be compressed to model the curves of deformities. Tightening or loosening of a tensioning wire 552 affects the amount of tensioning wire available and forces the wave springs 554 to find an equilibrium point that accounts for the space created by the tensioning wires. A tightened wire on one side of the vertebrae will allow for the opposite side of the model to form the convex side of a curve. The wires can be adjusted to desired lengths in desired positions to shape the springs to follow the path of the desired deformity. However, the wire adjustments do not independently adjust the springs. Each spring will move to an equilibrium position based on the space created by the tightened wires and the positions of the other springs. Depending on the space allowed by the wires, the springs can/will take on a wedge form.

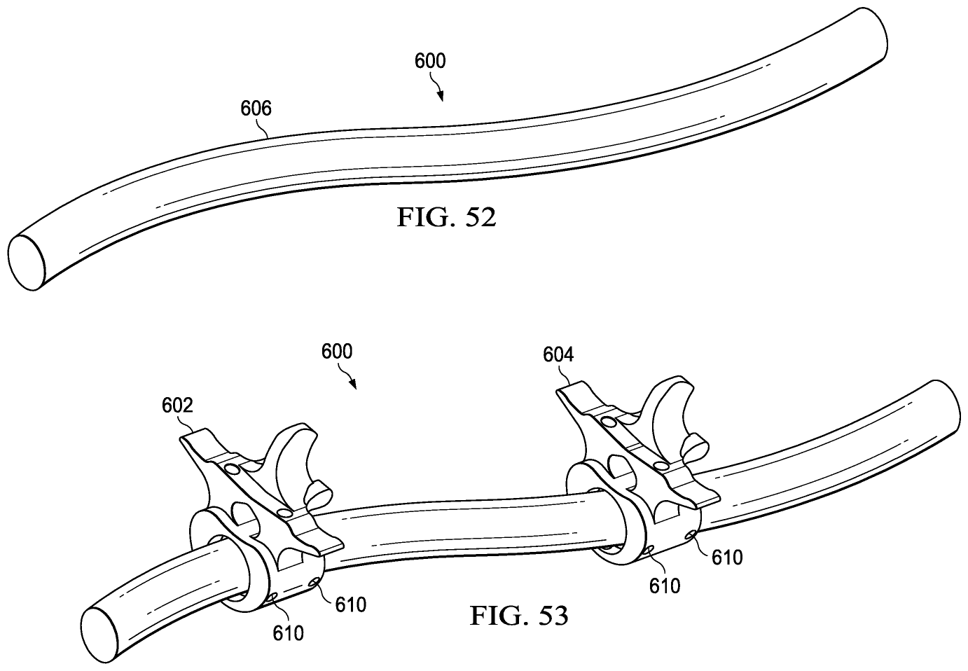

Referring to FIGS. 52 and 53, a representative example of another embodiment of a spine model is shown. The spine model 600 is useful for modeling transverse, coronal, and/or sagittal spinal misalignment and training in aligning human spines in need of such alignment. In the spine model 600 instead of individual discs separating adjacent vertebrae, there is one long cylindrical disc 606 that can extend the length of the spine. The cylindrical disc 606 can pass through the center of the each of the vertebrae, such as a first vertebrae 602 and a second vertebrae 604, as depicted in FIG. 53. In a sense, the vertebrae are threaded onto the cylindrical disc, and held in place at a spacing closely resembling that of a human spine. Instead of alignment pins and recessed portions, the vertebrae have a holes running all the way through, and cylindrical disc 606 can pass through these holes and be held in place by set screws, radial pins, and the like, such as the set screws 610. The spacing of the vertebrae in FIG. 53 is for illustration purposes, and does not necessarily represent an actual spacing on the spine model 600. The cylindrical disc 106 could be a continuous core material that can be manipulated to model the overall curve in both the sagittal and coronal planes. The rotation aspect of the model would be accounted for by orienting and attaching each vertebra at its desired angle.

The cylindrical disc 106 can be manufactured using 3D printing, machining, or molding of a desired elastic material, and it could provide the bending and derotation resistances in all three planes. The cylindrical disc 606 could be a pliable, self-supporting material that permits bending and holding a shape once bent. Moreover, the cylindrical disc 606 need not be exactly cylindrical, and could have a varying cross-section. For example, it could be tapered from top to bottom to create variable stiffness and therefore variable bending and rotational resistances.

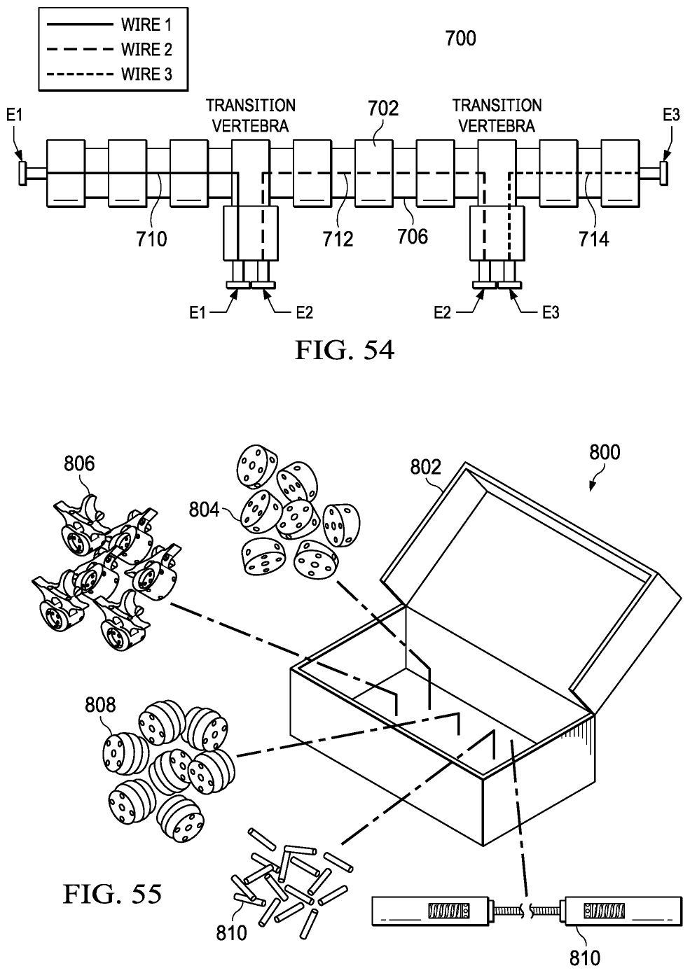

Referring to FIG. 54, a representative example of another embodiment of a spine model is shown. The spine model 700 is useful for modeling transverse, coronal, and/or sagittal spinal misalignment and training in aligning human spines in need of such alignment. The concept of spine model 700 is similar to the spine model 400, discussed above, but instead of a single tensioning wire, multiple tensioning wires can be utilized. That is, in the spine model 700 a different wire can run through each section of the spine model 700, allowing for different tensions and therefore bending resistances in these sections. In FIG. 4 there are shown three tensioning wires: tensioning wire one 710 having end points E1; tensioning wire two 712 having end points E2; and, tensioning wire three 714 having end points E3. A tightening mechanism, such as a threaded bolt can be disposed at any of the end points, and rotated to add or release tension from the tensioning wires. A transition vertebrae 704 can be disposed between each wire sections and include two paths, such as curved grooves, for the tensioning wires to enter/exit the spine model 700 at an angle, e.g., perpendicular, to the spine model 700 longitudinal axis. In an embodiment, a mechanism for securing the spine model 700, including the transition vertebrae 704 can include a bolt, spool, motor, or the like, to control the tension in each tensioning wire.

In addition to the modular benefits of the spine models disclosed herein, other features and benefits can be implemented. For example, an option can be added to have removeable facets and spinous processes on the vertebrae. Since these are sometimes removed in surgery, this would allow for more options during training and/or preoperative practice. It would allow for surgeons to choose whether or not to remove the part without ruining the vertebra, rendering it unusable again. Also, vertebra could be modeled such that they are split down the middle and can be taken apart and removed from the assembly without completely disassembling the whole model. This could be useful for modeling a vertebral body resection. The discs could also be modified so that they are made of several pieces and can be taken apart and removed from the model without disassembling the surrounding components, providing the option to add a fusion cage to the model. Further, another additional option is to create different sized discs or discs made of different material, allowing for differences in bending and rotational resistances throughout the model.

Referring now to FIG. 55, the components and benefits of a spine model can be supplied in the form of a kit. For example a spine model kit 800 can be supplied in one or more containers 802, with the container 802 containing a plurality of various spine model parts that can be combined to make a spine model, as described herein. For example, the spine model kit 800 can contain one or more of disc (or wedge) members 804 having a variety of various angles of the first and second faces, as described herein, one or more vertebrae 806 of various types, one or more multi-curved discs 808 of varying angular curvatures as described herein, a plurality of alignment pins 810, and/or a tensioning wire member 810. The one or more disc (or wedge) members 804, one or more vertebrae 806, one or more multi-curved discs 808, plurality of alignment pins 810, and tensioning wire member 810 may comprise any of the illustrative discs members, wedge members, vertebrae, multi-curved discs, alignment pins, and/or tensioning wire members shown and described herein or any combinations thereof. Other components as described herein for any of the disclosed spine models can be included in a kit 800 as well. In an embodiment a kit 800 includes instructions for making a spine model. In an embodiment, a kit 800 includes spine model parts that are manufactured according to specifications derived from imaging data of a human spine.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A spine model, the spine model comprising:
a. a disc, the disc comprising a first disc face and a second disc face, the first disc face and the second disc face being substantially parallel to each other and orthogonal to a rotational axis;
b. a fixed first vertebrae operationally joined to the disc at the first disc face such that the fixed first vertebrae cannot rotate about the rotational axis relative to the first disc face; and
c. a rotatable second vertebrae, rotatable about the rotational axis and operationally joined to the disc at the second disc face such that the rotatable second vertebrae cannot rotate about the rotational axis relative to the second disc face.

2. The spine model of claim 1, wherein the disc comprises a polymer.

3. The spine model of claim 1, wherein the disc comprises an elastomeric polymer.

4. The spine model of claim 1, wherein the first disc face is substantially planar and the second disc face is substantially planar.

5. The spine model of claim 1, wherein the fixed first vertebrae comprises vertebrae pin-receiving receptacles and the disc comprises disc pin-receiving receptacles, and the fixed first vertebrae is operationally joined to the first disc face by a plurality of pins, each of the plurality of pins secured in one of the vertebrae pin-receiving receptacles and one of the disc pin-receiving receptacles.

6. The spine model of claim 5, wherein the plurality of pins comprise stainless steel.

7. The spine model of claim 1, wherein the disc comprises an elastomeric polymer and the rotatable second vertebrae is rotatable about the rotational axis relative to the fixed first vertebrae.

8. A spine model, the spine model comprising:
a. a disc, the disc comprising a first disc face and a second disc face, the first disc face and the second disc face being non-parallel to each other, the first disc face being orthogonal to a first vertebrae axis and the second disc face being orthogonal to a second vertebrae axis;
b. a first vertebrae operationally joined to the disc at the first disc face such that the first vertebrae cannot rotate about the first vertebrae axis relative to the first disc face; and
c. a second vertebrae operationally joined to the disc at the second disc face such that the second vertebrae cannot rotate about the second vertebrae axis relative to the second disc face.

9. The spine model of claim 8, wherein the disc comprises a polymer.

10. The spine model of claim 8, wherein the disc comprises an elastomeric polymer.

11. The spine model of claim 8, wherein the first disc face is substantially planar and the second disc face is substantially planar.

12. The spine model of claim 8, wherein the first vertebrae comprises vertebrae pin-receiving receptacles and the disc comprises disc pin-receiving receptacles, and the first vertebrae is operationally joined to the first disc face by a plurality of pins, each of the plurality of pins secured in one of the vertebrae pin-receiving receptacles and one of the disc pin-receiving receptacles.

13. The spine model of claim 12, wherein the plurality of pins comprise stainless steel.

14. The spine model of claim 8, wherein the disc comprises an elastomeric polymer and the second vertebrae is rotatable about one of the first vertebrae axis and the second vertebrae axis relative to the first vertebrae.

15. A spine model, the spine model comprising:
a. a disc, the disc comprising a first disc face and a second disc face, the first disc face and the second disc face being non-parallel to each other, the first disc face being orthogonal to a first vertebrae axis and the second disc face being orthogonal to a second vertebrae axis, and wherein the disc comprises a disc central aperture;
b. a first vertebrae operationally joined to the disc at the first disc face such that the first vertebrae cannot rotate about the first vertebrae axis relative to the first disc face, and wherein the first vertebrae comprises a first vertebrae central aperture;
c. a second vertebrae operationally joined to the disc at the second disc face such that the second vertebrae cannot rotate about the second vertebrae axis relative to the second disc face, and wherein the second vertebrae comprises a second vertebrae central aperture; and
d. a tensioning wire that extends through the disc central aperture, the first vertebrae central aperture, and the second vertebrae central aperture, the tensioning wire being tensionable at one or both of a first and second end thereof to put the disc in compressive contact with both of the first vertebrae and the second vertebrae.

16. The spine model of claim 15, wherein the tensioning wire comprises a threaded portion, and is tensioned by a tensioning bolt rotatable upon the threaded portion.

17. The spine model of claim 15, wherein the disc comprises a polymer.

18. The spine model of claim 15, wherein the disc comprises an elastomeric polymer.

19. The spine model of claim 15, wherein the first disc face is substantially planar and the second disc face is substantially planar.

20. The spine model of claim 15, wherein the first vertebrae comprises vertebrae pin-receiving receptacles and the disc comprises disc pin-receiving receptacles, and the first vertebrae is operationally joined to the first disc face by a plurality of pins, each of the plurality of pins secured in a vertebrae pin-receiving receptacle and a disc pin-receiving receptacle.
